(19) United States
(12) Patent Application Publication
(10) Pub. No.: US 2024/0395059 A1
(43) Pub. Date: Nov. 28, 2024

(54) SYSTEM AND METHOD FOR GENERATING A MORPHOLOGICAL ATLAS OF AN EMBRYO

(71) Applicant: Centre for Intelligent Multidimensional Data Analysis Limited, Hong Kong (CN)

(72) Inventors: Zelin LI, Hong Kong (CN); Jianfeng CAO, Hong Kong (CN); Hong YAN, Hong Kong (CN)

(21) Appl. No.: 18/782,395

(22) Filed: Jul. 24, 2024

Related U.S. Application Data
(63) Continuation-in-part of application No. 17/536,377, filed on Nov. 29, 2021, now abandoned.

(51) Int. Cl. G06V 20/69; G06V 10/26; G06V 10/34; G06V 10/778; G06V 10/82

(52) U.S. Cl. CPC G06V 20/695; G06V 10/26; G06V 10/34; G06V 10/7788; G06V 10/82; G06V 2201/03

(57) ABSTRACT

A method for generating a morphological atlas of an embryo including the steps of receiving a plurality of 3D images of the embryo representative of the morphological process of embryonic cells from a first predetermined cell population to a second predetermined cell population; processing the plurality of 3D images to derive nucleus lineage information associated with each nucleus of the embryonic cells during the morphological process; performing a membrane segmentation procedure to segment the 3D images into membrane segments; and combining the nucleus lineage information and the membrane segments to generate the morphological atlas of the embryo.

### CROSS-REFERENCE TO RELATED APPLICATION

This application is a continuation-in-part of a co-pending U.S. patent application Ser. No. 17/536,377, filed Nov. 29, 2021, which is incorporated herein by reference in its entirety.

### TECHNICAL FIELD

This invention relates to a method and system for generating a morphological atlas of an embryo.

### BACKGROUND

Embryogenesis in metazoans involves multidimensional spatiotemporal cellular changes, including cell proliferation, differentiation, and morphogenesis. During metazoan embryogenesis, cell morphology is tightly associated with several biological processes, including cell-cycle control, spindle formation, cell-fate asymmetry and differentiation, intercellular signalling, cytomechanics, morphogenesis, and organogenesis. To study the characteristics of cell division, a deeper understanding of changes in cell morphology during development (i.e. cell shape, cell size, and cell neighborhood) is desired.

Although recent advances in confocal microscopy have promoted in vivo 4D imaging of an embryo throughout embryogenesis, this typically involves large quantities of volumetric imaging data which makes visual identification tedious. Deep-learning-based methods are promising tools for recognition tasks, such as denoising image synthesis and segmentation. A system and method for efficient analysis of image data is desired.

### SUMMARY OF THE INVENTION

According to a first aspect of the invention, there is provided a method for generating a morphological atlas of an embryo including the steps of: receiving a plurality of 3D images of the embryo representative of the morphological process of embryonic cells from a first predetermined cell population to a second predetermined cell population, processing the plurality of 3D images to derive nucleus lineage information associated with each nucleus of the embryonic cells during the morphological process, performing a membrane segmentation procedure to segment the 3D images into membrane segments, and combining the nucleus lineage information and the membrane segments to generate the morphological atlas of the embryo.

In an embodiment of the first aspect, the membrane segmentation procedure includes a machine learning processor comprising a UNet Transformer (TUNETr) arranged to be pre-trained by annotated images representing a range of embryonic developmental stages and imaging conditions.

In an embodiment of the first aspect, the TUNETr is adapted to utilize the capability of a large deep neural network model for convoluting voxels of 3D volumes with corresponding neighboring voxels.

In an embodiment of the first aspect, the membrane segmentation procedure utilizes a topology-constraint loss function in voxel-wise recognition to regularizing cellular boundaries.

In an embodiment of the first aspect, the topology-constraint loss function comprises a geometrical loss L_{g} and topological loss Lₜ, wherein the geometrical loss is derived from mean square error (MSE) and the topological loss is a topological structural difference of the prediction and ground truth 3D images (Euclidean distance transformed).

In an embodiment of the first aspect, the annotated images are carried out by a human visual inspection method and a trained DNN method, such that the human visual inspection method is adapted to annotate a set of ground truth (GT) images for training the DNN for annotation.

In an embodiment of the first aspect, the annotated images comprise synthetic pseudo GT images.

In an embodiment of the first aspect, the synthetic pseudo GT images are generated by a step of manually adjusting the set of GT images.

In an embodiment of the first aspect, the step of manually adjusting the set of ground truth images comprises a human-in-the-loop step, wherein the human-in-the-loop step provides location prompts for tuning, eliminating irrelevant surroundings, and refining membrane recognition to reasonable positions and sizes to form the synthetic pseudo GT images.

In an embodiment of the first aspect, the synthetic pseudo GT images comprise membrane annotations which are constrained from real cell shape and embryos' edges that are tripled in thickness, for dragging DNN's attentions to the weak imaging areas.

In an embodiment of the first aspect, the TUNETr is adapted to generate reliable nucleus-prompting seeds and avoid erroneous segmentation in extremely ambiguous imaging areas.

In an embodiment of the first aspect, the TUNETr is adapted to use independent locations seeds to group points near cell margins and assign weights to graph edges to avoid erroneous segmentation in extremely ambiguous imaging areas.

In an embodiment of a second aspect of the present invention, there is provided a system for generating a morphological atlas of an embryo, comprising:
a cell imaging unit arranged to receive a plurality of 3D images of the embryo representative of the morphological process of embryonic cells from a first predetermined cell population to a second predetermined cell population;
a nucleus tracing processor arranged to process the plurality of 3D images to derive nucleus lineage information associated with each nucleus of the embryonic cells during the morphological process;
an Encoding Module arranged to perform a membrane segmentation procedure to segment the 3D images into membrane segments; and
a Decoding Module arranged to combine the nucleus lineage information and the membrane segments to generate the morphological atlas of the embryo.

In an embodiment of a second aspect, the Encoding Module comprises a Swin Transformer Convolution Encoder Module.

In an embodiment of a second aspect, the Swin Transformer Convolution Encoder Module comprises a Patch Partition layer, a Linear Embedding layer, and a plurality of Swin Transformer Blocks (STBs) and Linear Patch Merging (LPM) layers.

In an embodiment of a second aspect, the each of the Swin Transformer blocks is immediately followed by a Linear Patch Merging (LPM) layer.

In an embodiment of a second aspect, the Encoder Module comprises four Swin Transformer blocks and four Linear Patch Merging layers.

In an embodiment of a second aspect, the Decoder Module comprises a plurality of Convolution Residual Regression Modules, wherein each of the Convolution Residual Regression Modules is adapted to take an output from a corresponding layer in the Encoder Module and add to an output from the previous layer of Decoder Module.

In an embodiment of a second aspect, each of the Swin Transformer blocks comprises one or more consecutive Transformer Blocks.

In an embodiment of a second aspect, each of the Transformer Blocks comprises a shifted window-based multi-headed self-attention (MSA) module and a Multilayer Perceptron (MLP) layer, wherein each MSA module and MLP layer has a Layer Normalisation (LN) layer 1146 is applied therebefore, and a residual connection is applied after each module.

In an embodiment of another aspect, the membrane segmentation procedure includes a machine learning processor arranged to process the 3D images of the embryo to create a discrete distance map representative of the positions of membranes within the 3D images.

In an embodiment of another aspect, the machine learning processor uses a distance aware neural network trained to determine the positions of the membranes within the 3D images with the pixel location of the membranes.

In an embodiment of another aspect, the membrane segmentation procedure further includes the steps of a seeding procedure and a watershed segmentation procedure to perform the membrane segmentation.

In an embodiment of another aspect, the step of combining the nucleus lineage information and the membrane segments identifies the embryonic cells and cavity within the 3D image.

In an embodiment of another aspect, the combination of the nucleus lineage information and the membrane segments is arranged to devise cell shape, cell size, cell-cell contact, or any combination thereof.

In an embodiment of another aspect, the nucleus lineage information, the membrane segments, cell shape, cell size, cell-cell contact, or any combination thereof, is presented as the morphological atlas of the embryo undergoing the morphological process from the first predetermined cell population to the second predetermined cell population.

In an embodiment of another aspect, the first predetermined cell population is 4, and the second predetermined cell population is 350.

In an embodiment of another aspect, the embryo is a Caenorhabditis elegans embryo.

In an embodiment of another aspect, the embryo is a Caenorhabditis elegans transgenic strain that expresses a GFP fluorescence marker and/or a mCherry fluorescence marker in the nuclei and/or membranes of the embryonic cells.

According to another aspect of the invention, there is provided a system for generating a morphological atlas of an embryo including a cell imaging unit arranged to receive a plurality of 3D images of the embryo representative of the morphological process of embryonic cells from a first predetermined cell population to a second predetermined cell population, a nucleus tracing processor arranged to process the plurality of 3D images to derive nucleus lineage information associated with each nucleus of the embryonic cells during the morphological process, a membrane segmentation processor arranged to perform a membrane segmentation procedure to segment the 3D images into membrane segments; and a cell identification processor arranged to combine the nucleus lineage information and the membrane segments to generate the morphological atlas of the embryo.

In an embodiment of another aspect, the membrane segmentation processor includes a machine learning processor arranged to process the 3D images of the embryo to create a discrete distance map representative of the positions of the membranes within the 3D images.

In an embodiment of another aspect, the machine learning processor uses a distance aware neural network trained to determine the positions of the membranes within the 3D images with the pixel location of the membranes.

In an embodiment of the second aspect, the membrane segmentation procedure further includes the steps of a seeding procedure and a watershed segmentation procedure to segment the 3D images into the membrane segments.

In an embodiment of another aspect, the cell identification processor is arranged to combine the nucleus lineage information and the membrane segments to identify the embryonic cells and cavity within the 3D image.

In an embodiment of another aspect, the cell identification processor is arranged to combine the nucleus lineage information and the membrane segments to devise cell shape, cell size, cell-cell contact, or any combination thereof.

In an embodiment of another aspect, the nucleus lineage information, the membrane segments, cell shape, cell size, cell-cell contact, or any combination thereof, is presented as the morphological atlas of the embryo undergoing the morphological process from the first predetermined cell population to the second predetermined cell population.

In an embodiment of another aspect, the first predetermined cell population is 4, and the second predetermined cell population is 350.

In an embodiment of another aspect, the embryo is a Caenorhabditis elegans embryo.

In an embodiment of another aspect, the embryo is a Caenorhabditis elegans transgenic strain that expresses a GFP fluorescence marker and/or a mCherry fluorescence marker in the nuclei and/or membranes of the embryonic cells.

The present invention advantageously provides a method and system that combines automated segmentation of membranes with automated cell lineage tracing to quantify morphological parameters of embryonic cells in developing embryos. A 3D atlas of cell morphology for an embryo is generated, including cell shape, volume, surface area, migration, nucleus position, and cell-cell contact.

In one embodiment, the membrane segmentation procedure includes a machine learning processor arranged to process the 3D images of the embryo to create a discrete distance map representative of the positions of membranes within the 3D images. Preferably, the machine learning processor uses a distance aware neural network trained to determine the positions of the membranes within the 3D images with the pixel location of the membranes.

The discrete distance map provides a prediction probability distribution of the membranes thereby allowing for effective membrane segmentation, including membranes with weak signal.

In another embodiment, the membrane segmentation procedure further includes the steps of a seeding procedure and a watershed segmentation procedure to perform the membrane segmentation. The seeding strategy beneficially reduces over-segmentation errors.

Advantageously, the step of combining the nucleus lineage information and the membrane segments identifies the embryonic cells and cavity within the 3D image, and the combination of the nucleus lineage information and the membrane segments is arranged to devise cell shape, cell size, cell-cell contact, or any combination thereof. Systematic quantification of these factors aids in the prediction of essential regulatory activities that manifest as stereotyped morphological dynamics during embryonic development.

In a preferred embodiment, the embryo is a Caenorhabditis elegans transgenic strain that expresses a GFP fluorescence marker and/or an mCherry fluorescence marker in the nuclei and/or membranes of the embryonic cells. In an example, the first predetermined cell population is 4, and the second predetermined cell population is 350.

In a most preferred embodiment, the nucleus lineage information, the membrane segments, cell shape, cell size, cell-cell contact, or any combination thereof, is presented as the morphological atlas of the embryo undergoing the morphological process from the first predetermined cell population to the second predetermined cell population. The invention thus provides an efficient and accurate system and method for the reconstruction and visualization of 3D shapes and temporal changes of embryonic cells during development.

### BRIEF DESCRIPTION OF THE DRAWINGS

Embodiments of the present invention will now be described, by way of example, with reference to the accompanying drawings in which:

FIG. 1 is a block diagram of a computer system arranged to be implemented to operate as a system for generating a morphological atlas of an embryo in accordance with an example embodiment.

FIG. 2 is a block diagram of a system for generating a morphological atlas of an embryo in accordance with an example embodiment.

FIG. 3 is a flowchart of a method for generating a morphological atlas of an embryo in accordance with an example embodiment.

FIG. 4A shows 3D images of GFP-labeled nuclei (green) and mCherry-labeled membranes (red) of embryonic cells at the 2-4 cell stages in accordance with an example embodiment.

FIG. 4B shows 3D images of GFP-labelled nuclei (green) and mCherry-labelled membranes (red) of embryonic cells at the 4-350 cell stages in accordance with an example embodiment.

FIG. 4C shows images of nuclei positions of the embryonic cells from the 4-350 cell stages as determined by a nucleus tracing processor in accordance with an example embodiment.

FIG. 5A is a bar chart showing the dice ratio generated during the membrane segmentation procedure in accordance with an example embodiment.

FIG. 5B is a graph showing the results of the membrane segmentation procedure in accordance with an example embodiment.

FIG. 5C is a graph illustrating the benchmarking of the membrane segmentation procedure in accordance with an example embodiment.

FIG. 6 is a schematic diagram of a transformer according to an embodiment of the present invention.

FIG. 7 is a schematic diagram of a transformer architecture in accordance with an embodiment of the present invention.

FIG. 8 is a schematic diagram of a workflow of a transformer of an embodiment of the present invention.

FIG. 9 is a schematic diagram of two graphical interfaces of a software for the transformer of an embodiment of the present invention.

FIG. 10 is a schematic diagram of another graphical interface of a software application for the transformer of an embodiment of the present invention.

FIG. 11 is a schematic diagram of 3D images processing dataflow of running output from the transformer network of TUNETr, Delaunay-Watershed graphical algorithm.

FIG. 12 is a schematic diagram that shows qualitative comparison between TUNETr and other existing SOTA segmentation algorithms. 2D YZ view (upper row) and 3D side view (lower row) of the ground truth segmentation and segmentations generated from VNet, UNETR, SwinUNETR, CShaper, CShaper++, Cellpose3D, and StarDist3D at 550-cell stage in C. elegans.

FIG. 13 is a schematic diagram of quantitative evaluation of segmentation methods including the CTransformer in accordance with an embodiment of the present invention.

FIG. 14 shows five columns behind giving membrane recognition results from 5 typical DNN models including the CTransformer in accordance with an embodiment of the present invention.

FIG. 15 shows the time-lapse Analysis of Cellular Segmentation Performance.

FIG. 16 is a schematic diagram of a workflow of DELICATE in accordance with an embodiment of the present invention.

FIG. 17 is a diagram that shows the characterization of errors by StarryNite in C. elegans embryo.

FIG. 18 is a diagram that shows the raw fluorescence images associated with errors shown in FIG. 17B.

FIG. 19 shows an image enhancement workflow of DELICATE-Deep learning cell nuclei enhancing technology.

FIG. 20 is a diagram that shows comparable enhancement of image quality for another independent embryo as those shown in FIGS. 19B and C.

FIG. 21 is a diagram that shows a stark decrease in the occurrence of errors in nuclei segmentation and tracing after image enhancement.

FIG. 22 is a diagram that shows classes of errors are substantially reduced after image enhancement as in FIG. 3B except that errors were counted from ˜4 to ˜160-cell stages.

FIG. 23 is a diagram that shows comparison of lineage tree up to ˜160-cell stage from the same embryo output by StarryNite without manual curation before (A) and after image enhancement (B).

FIG. 24 is a diagram that shows comparison of lineage tree from ˜160 to ˜360-cell stage of the same embryo output by StarryNite without manual curation before (A) and after image enhancement (B).

FIG. 25 is a diagram that shows the graphic user interfaces of a CShaperApp according to an embodiment of the present invention consists of five functional components: (FIG. 25A) Preprocess, (FIG. 25B) Segmentation, (FIG. 25C) Analysis, (FIG. 25D) Result, and Train for model retraining adapted to different datasets.

FIG. 26 is a diagram that shows experiment results on the dataset from spheresDT/Mpacts-PiCS. Two cell segmentation examples of “TL2_2_t2-6” processed with CShaperApp according to an embodiment of the present invention in (FIG. 27A) and (FIG. 27B), respectively.

FIG. 27 is a diagram showing experiment results on the dataset from BCOMS. Two cell segmentation examples at the 12- and 24-cell stages processed with CShaperApp according to an embodiment of the present invention in (FIG. 27A) and (FIG. 27B), respectively.

### DETAILED DESCRIPTION OF THE PREFERRED EMBODIMENT

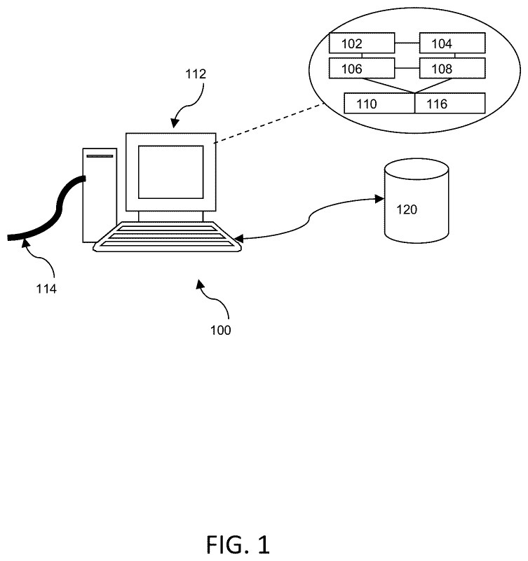

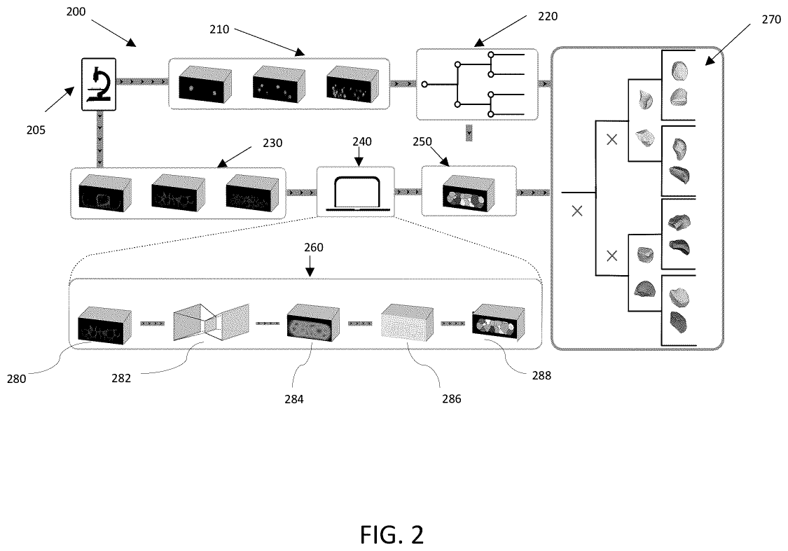

With reference to FIGS. 1 and 2, an embodiment of the present invention is illustrated. This embodiment is arranged to provide a system and method for generating a morphological atlas of an embryo, comprising: receiving a plurality of 3D images of the embryo representative of the morphological process of embryonic cells from a first predetermined cell population to a second predetermined cell population, processing the plurality of 3D images to derive nucleus lineage information associated with each nucleus of the embryonic cells during the morphological process, performing a membrane segmentation procedure to segment the 3D images into membrane segments, and combining the nucleus lineage information and the membrane segments to generate the morphological atlas of the embryo.

In this example embodiment, the interface and processor are implemented by a computer having an appropriate user interface. The computer may be implemented by any computing architecture, including portable computers, tablet computers, stand-alone Personal Computers (PCs), smart devices, Internet of Things (IOT) devices, edge computing devices, client/server architecture, “dumb” terminal/mainframe architecture, cloud-computing based architecture, or any other appropriate architecture. The computing device may be appropriately programmed to implement the invention.

The system and method of the invention are arranged to generate a morphological atlas of an embryo by detecting cell membranes and building up cell shapes of embryonic cells in 3D and automatically segmenting the cell images at a cellular level such that scientists are able to decipher the contents of these images quickly and with minimal input. The system and method of the invention thus can characterize cell shapes and surface structures, and advantageously provide 3D views of cells at different time points.

Turning first to FIG. 1, there is a shown a schematic diagram of a computer system or computer server 100 which is arranged to be implemented as an example embodiment of a system for generating a morphological atlas of an embryo. This embodiment comprises a server 100 which includes suitable components necessary to receive, store, and execute appropriate computer instructions. The components may include a processing unit 102, including Central Processing Units (CPUs), Math Co-Processing Unit (Math Processor), Graphic Processing Unit (GPUs) or Tensor Processing Units (TPUs) for tensor or multi-dimensional array calculations or manipulation operations, read-only memory (ROM) 104, random access memory (RAM) 106, and input/output devices such as disk drives 108, input devices 110 such as an Ethernet port, a USB port, etc. Display 112 such as a liquid crystal display, a light emitting display, or any other suitable display and communications links 114 may also be present. The server 100 may include instructions that may be included in ROM 104, RAM 106, or disk drives 108 and may be executed by the processing unit 102. There may be provided a plurality of communication links 114 which may variously connect to one or more computing devices such as a server, personal computers, terminals, wireless or handheld computing devices, Internet of Things (IoT) devices, smart devices, and edge computing devices. At least one of a plurality of communication links may be connected to an external computing network through a telephone line or other type of communication links.

The server 100 may also include storage devices such as a disk drive 108 which may encompass solid state drives, hard disk drives, optical drives, magnetic tape drives, or remote or cloud-based storage devices. The server 100 may use a single disk drive or multiple disk drives, or a remote storage service. The server 100 may also have a suitable operating system 116 which resides on the disk drive or in the ROM of the server 100.

The computer or computing apparatus may also provide the necessary computational capabilities to operate or to interface with a machine learning network, such as a neural network, to provide various functions and outputs. The neural network may be implemented locally, or it may also be accessible or partially accessible via a server or cloud-based service. The machine learning network may also be untrained, partially trained, or fully trained, and/or may also be retrained, adapted, or updated over time.

FIG. 2 is a block diagram of a system 200 for constructing a 4D morphological atlas of an embryo during embryogenesis. A cell imaging unit 205 is arranged to receive a plurality of 3D images of the embryo representative of the morphological process of the embryonic cells from a first predetermined cell population to a second predetermined cell population. Preferably, the embryos are from a Caenorhabditis elegans transgenic strain that ubiquitously expresses both a green fluorescent protein (GFP) and a red mCherry fluorescence marker in the embryonic cell nuclei and membranes, respectively, throughout embryonic development.

A nucleus tracing processor 210 is arranged to process the plurality of 3D images to derive nucleus lineage information 230 associated with each nucleus of the embryonic cells during the morphological process, for example as a cell lineage tree as shown in FIG. 2.

A membrane segmentation processor 282 performs an automatic segmentation 240 in which a membrane segmentation procedure 260 segments the 3D membrane images 230 into distinct membrane segments. The membrane segmentation processor 282 is a trained distance-aware neural network module that is able to produce a discrete distance map 284 from the raw image 280 of the membranes. The membrane segmentation processor 282 is trained to determine the positions of the membranes within the 3D images with the pixel location of the membranes. The membrane segmentation procedure 260 further includes the steps of minima clustering which serves as a seeding procedure 286, and a watershed segmentation procedure 288 to segment the 3D images 230 into the membrane segments.

The segmentation of cell membranes, unlike cell nuclei that are localized and well-separated ellipsoid components, is well known to be a difficult task due to the thin planar structure of membranes that form complicated networks. Accordingly, it may be difficult to obtain a strong signal of the membranes and laser attenuation makes segmentation of membranes more challenging, problems that are exacerbated when the membrane is parallel to the focal plane-affecting the overall quality of the membrane image. The generation of a discrete distance map, instead of segmenting cells as a binary classification task directly, allows for accurate and reliable segmentation of the cell membranes. Further, by learning to capture multiple discrete distances between image pixels, the membrane segmentation processor 230 extracts the membrane contour while considering shape information, rather than just intensity features thereby allowing for effective segmentation of membranes with weak or weaker signals.

The cell identification processor 250 then combines the nucleus lineage information 220 derived from fcsha with the membrane segments to identify the embryonic cells and cavity within the 3D image. The membrane-wrapped compartments in the segmentations with a nucleus are denoted as cells and the membrane-wrapped compartments without a nucleus are denoted as a cavity. The cell identification processor 250 uses this information to devise morphological parameters such as cell shape, cell size, cell-cell contact, or any combination of these parameters. Time-lapse 3D cell shapes, or any other morphological parameters or combinations thereof, across development with defined cell identity are generated as a cell shape lineage 270.

The nucleus lineage information 220, the membrane segments, cell shape, cell size, cell-cell contact, or any combination thereof, is presented as a morphological atlas of the embryo undergoing the morphological process from a first predetermined cell population, for example 4 cells, to a second predetermined cell population, for example 350 cells.

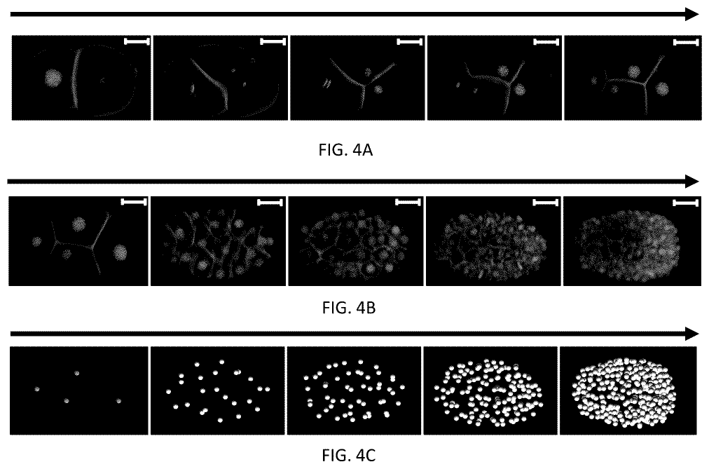

FIG. 4A shows 3D images of GFP-labelled nuclei (green) and mCherry-labelled membranes (red) of embryonic cells at the 2-4 cell stages and FIG. 4B shows 3D images of embryonic cells at the 4-350 cell stages. FIG. 4C shows images of nuclei positions of the embryonic cells from the 4-350 cell stages determined by the nucleus tracing processor 210.

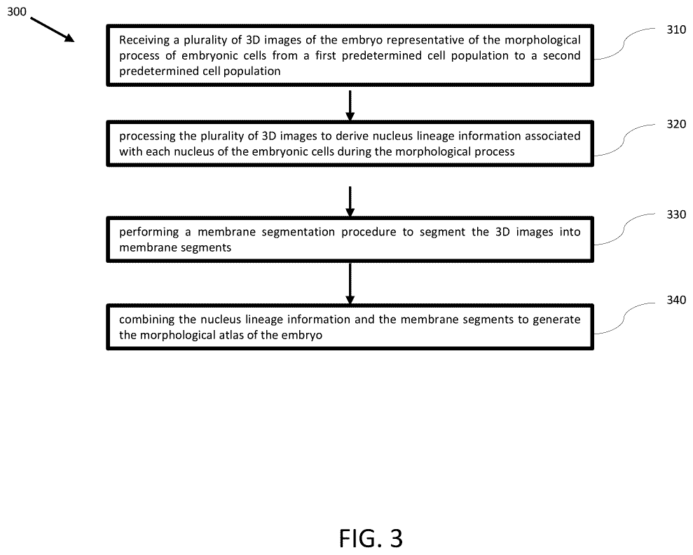

With reference to FIG. 3, the present invention is also directed to a method for generating a morphological atlas of an embryo as illustrated in the flowchart 300.

The first step 310 involves receiving a plurality of 3D images of the embryo representative of the morphological process of embryonic cells from a first predetermined cell population, for example 4 cells, to a second predetermined cell population, for example 350 cells. In a most preferred embodiment, the embryo is a Caenorhabditis elegans transgenic strain that expresses a GFP fluorescence marker and/or a mCherry fluorescence marker in the nuclei and/or membranes of the embryonic cells.

The second step 320 involves processing the plurality of 3D images to derive nucleus lineage information 220 associated with each nucleus of the embryonic cells during the morphological process.

A membrane segmentation procedure 260 is performed in step 330 to segment the 3D images into membrane segments. The membrane segmentation procedure 260 includes a machine learning processor 282 arranged to process the 3D images of the embryo to create a discrete distance map 284 representative of the positions of membranes within the 3D images. The machine learning processor uses a distance-aware neural network to determine the positions of the membranes within the 3D images with the pixel locations of the membranes.

In a preferred embodiment, the membrane segmentation procedure 260 includes the steps of a seeding procedure 286 and a watershed segmentation procedure 288 to perform the membrane segmentation.

Step 340 involves combining the nucleus lineage information 220 and the membrane segments to generate a morphological atlas of the embryo. This step identifies the embryonic cells and cavity within the 3D image and the combination of the nucleus lineage information and the membrane segments is used to devise cell shape, cell size, cell-cell contact, or any combination thereof. The nucleus lineage information, the membrane segments, cell shape, cell size, cell-cell contact, or any combination thereof, is presented as the morphological atlas of the embryo undergoing the morphological process from the first predetermined cell population to the second predetermined cell population.

Existing image analysis systems are directed at detecting cell nuclei with a poor cell membrane image quality, thus hampering reconstruction of cell shapes. Image segmentation is a critical process in developmental and cell biology and traditionally involves meticulous and time-consuming manual labelling of cell images. The segmentation of time-lapsed 3D images of cell division is currently lacking a reliable algorithm.

The system and method for generating a morphological atlas of the present invention advantageously provide a research tool that can reconstruct and visualize 3D shapes and temporal changes of cells, automating, simplifying, and substantially speeding up the analysis process. The system of the present invention can detect cell membranes, build up cell shapes in 3D, and automatically segment the cell images at the cell level thus characterizing cell shapes and surface structures, providing 3D views of cells at different time points. Utilizing a distance aware neural network that captures multiple discrete distances between image pixels, membrane contour and shape information is captured thus achieving a high accuracy of identifying cells.

Although not required, the embodiments described with reference to the Figures can be implemented as an application programming interface (API) or as a series of libraries for use by a developer or can be included within another software application, such as a terminal or personal computer operating system or a portable computing device operating system. Generally, as program modules include routines, programs, objects, components, and data files assisting in the performance of particular functions, the skilled person will understand that the functionality of the software application may be distributed across a number of routines, objects, or components to achieve the same functionality desired herein.

It will also be appreciated that where the methods and systems of the present invention are either wholly implemented by computing systems or partly implemented by computing systems then any appropriate computing system architecture may be utilized. This will include standalone computers, network computers, and dedicated hardware devices. Where the terms “computing system” and “computing device” are used, these terms are intended to cover any appropriate arrangement of computer hardware capable of implementing the function described.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

Any reference to prior art contained herein is not to be taken as an admission that the information is common general knowledge unless otherwise indicated.

### EXAMPLES

### Example 1

### Methods

Preparation of C. elegans Strain

All animals were maintained on NGM plates seeded with OP50 at room temperature. Using Gibson Assembly, the construct Phis-72::PH(PLC1delta1)::mCherry::pie-1-3′UTR was made and cloned into a miniMos vector for transgenesis. The His-72 promoter and pie-1 UTR were used to achieve broad expression in both the soma and germline. A membrane labeling strain ZZY0637, carrying a single copy of this transgene, was generated using the mini-Mos technique. It was crossed with the nucleus labeling strain, RW10029, which ubiquitously expresses a fusion between histone (HIS-72) and GFP, enabling automated tracing and identification of nuclei. Both the nucleus and membrane markers were rendered homozygous in the resulting strain, ZZY0655, before automated lineaging and membrane segmentation.

### Image Acquisition

One- to four-celled embryos were dissected from the adult worms. They were mounted for imaging using 1% methylcellulose in Boyd's buffer with 20 μm Polybead® microspheres (Polvsciences, Inc.) Imaging was performed with an inverted Leica SP5 and SP8 confocal microscope equipped with two hybrid detectors at a constant ambient temperature of 21° C. Images were consecutively collected for both GFP and mCherry channels using a water immersion objective. By using a resonance scanner, both channels were imaged with scanning speed of 8000 Hz with a frame size of 712×512 pixels per channel. The excitation laser beams used for GFP and mCherry are 488 nm (SP5 and SP8) and 594 nm (SP5) or 552 nm (SP8), respectively. Histone::GFP was used as a lineaging marker for cell tracing later, whereas PH2::mCherry was used as a membrane marker. Fluorescence images from 68 (SP5) or 70 (SP8) Z-steps were collected consecutively for three embryos per imaging session with a Z-resolution of 0.42 μm (SP5) or 0.43 μm (SP8) from top to bottom of the embryo for every timepoint, which was at ˜1.5-min interval. Images were continuously collected for at least 130 time points during which the cell count would reach over 350 in a wild-type embryo. The entire imaging duration was divided into four time blocks by time point that is 1-60-61-130-131-200 and 201-240. Z axis compensation was 0.4-4% for the 488 nm laser and 19-95% for the 594 nm laser in SP5, whereas 0.1-0.3% for the 488 nm laser (SP8) and 2-10% for the 552 nm laser (SP8). The pinhole sizes for the four blocks were 2.3, 2, 1.6, and 1.3 AU, respectively. Prior to image analysis, all images were subjected to deconvolution followed by resizing into isotonic volume images with a resolution of either 0.22 μm (for training or evaluation) or 0.25 μm (for morphological atlas generation).

### Nucleus Tracing and Lineaging

The nuclei images were segmented and identified using StarryNite and visualized using AceTrec21. The lineaging errors were manually corrected up to the 350-cell stage. The data quality was confirmed using quality-control standards. First, all the embryos must start to be imaged before AB2 divisions so that information of the four-cell stage can be obtained (i.e., ABa, ABp, EMS, and P2), which is essential for spatial normalization of different embryos. Second, the full lifespans of AB4-AB128, MS1-MS16, E1-E8, C1-C8, D1-D4, P3, and P4 cells have to be recorded. Third, their descendants, namely AB256, MS32, E16, C16, D8, Z2, and Z3 cells, have to be present for at least one time point Finally, the nucleus information, including position and name, was output in a separate file to be used for cell-membrane segmentation.

### Manual Annotation of Cell

A new data set was annotated and used to train the DMapNet and benchmark CShaper against existing methods. A gold standard data set was generated in a semiautomatic manner, in which segmentation errors from software were manually corrected by experts. The membrane stack was first pre-segmented by a traditional method for 3D membrane morphological segmentation (3DMMS), and then the output was checked by two experts with an interactive tool for semiautomatic segmentation of multi-modality biomedical images (ITK-SNAP) slice-by-slice. To aid manual examination of cavities formed among the neighboring cells, nuclei images were incorporated alongside the membrane-based images. Most annotated embryos had fewer than 100 cells to prevent the deterioration of annotation accuracy with image quality and subsequent segmentation errors introduced by 3DMMS. The annotations are composed of cell-wise regions, which can be easily transformed into membrane masks through morphological operations. For training, 54 volumetric stacks with an average of 65 cells in each were annotated. Another 21 stacks with an average of 52 cells in each were also annotated in parallel for independent evaluation.

### Distance-Constrained Learning

During long-duration time-lapse imaging, it is desirable to collect each pixel with a sufficient number of photons, but the imaging frequency has to be limited to keep the embryo alive. Segmenting the embryo with low image quality is a challenging task. To solve this problem, a distance-aware network, DMapNet, is proposed to learn the cell shapes implicitly. DMapNet is able to discriminate weak membranes, especially in the periphery where only a single layer of membrane exists.

Given the input image I, we define Φᵢ(I) as the corresponding ground truth of the binary membrane at pixel i, where foreground membrane and background pixels have values 1 and 0, respectively. With the membrane mask forming a single-pixel surface, the distance map M is formulated as:

$${ℳ}_{i} = \{ \begin{matrix}{min}_{{Φ}_{j} = 1} \{ {( x - {x}_{0} )}^{2} + {( y - {y}_{0} )}^{2} + {( z - {z}_{0} )}^{2} \} , & {Φ}_{i} = 0 \\ 0 , & {Φ}_{i} = 1\end{matrix} \qquad ( 3 )$$

$$ℳ = τ ( max \{ ℳ \} - ℳ , d ) \qquad ( 4 )$$

where x, y, z and x₀, y₀, z₀ represent the coordinates of pixels i and j, respectively. In Eq. (4), we reverse the distance map to keep it monotonically decreasing from the membrane to the background. The background here includes both cell interiors and external embryo background. Subsequently, a truncation function τ(*, d) sets values above d to d or otherwise retains the value. Due to the lack of distinctive features among far-away voxels. d is chosen such that it constitutes a smooth transformation from the foreground membrane to the background. By predicting M, DMapNet outputs the unnormalized probability of the voxel being the membrane. \hat{ }68, M is further nonlinearly discretized into M^{d}⊂{0, 1, . . . , K}³, the learning target, with smaller intervals around the membrane mask. The cross-entropy loss used to evaluate the learning progress is defined as:

$$l = {\sum }_{l = 1}^{N} {\sum }_{k = 1}^{K} {ξ}_{k} {ω}_{i , k} ( {ℳ}_{i , k}^{d} log {P}_{i , k} + ( 1 - {ℳ}_{i , k}^{d} ) log ( 1 - {P}_{i , k} ) )$$

M_{i,k}^{d} is the kth element of the one-hot target vector at pixel i, and P_{(i,k)} is the counterpart in the output of DMapNet. N and K are the numbers of pixels and distance intervals, respectively. The importance of different classes is adjusted by the fixed weighting term ζₖ, which inclines to classes near the membrane. We also incorporate interclass relationships into the loss through an interclass weighting term, ωᵢₖ. Compared with ξₖ, ωᵢₖ dynamically changes depending on different predicted classes. This strategy is derived from the assumption that in ordered class prediction, one class closer to the ground truth is supposed to have a larger predicted probability. For example, for class k=1 a higher penalty should be imposed to a predicted class [symbol] =15 than that of \hat{k}′=2. Therefore, if the Kth interval denotes the center mask of the membrane, interclass weight ω_{i,k} is calculated with:

$${ω}_{i , k} = exp ( \frac{\vert k - {ℳ}_{i}^{d} \vert}{K} ) \qquad ( 6 )$$

where Mᵢ^{d} is the ground truth class at pixel i.

### Network Structure

A pseudo-3D data flow is utilized throughout the network of DMapNet. In confocal imaging, a 3D stack is acquired by optical sectioning of embryos in the depth direction. Considering the thickness of the membrane, as well as the elongated light volume emitted by a single fluorescent molecule, only 24 consecutive slices are cropped as the input to DMapNet. It follows the structure of the U-Net with high-level abstraction information extracted by a down-sampling path and low-level features assembled by an up-sampling path. To ensure efficient gradient propagation. multiple residua blocks are leveraged at different down-sampling levels. While a 3×3×3 kernel can be decomposed into 3×3×1 and 1×1×3 kernels, the residual block only includes the 3××1 kernel in addition to the group normalization and Parametric Rectified Linear Unit layers. Before the max pooling, the 1×1×3 kernel is used to fuse the features of multiple channels. Dilation convolution is added to enlarge the receptive field. To aid the higher layers retain the raw image information, the input is scaled down and concatenated with corresponding high-level feature maps, which also boosts the performance in segmenting cells of different sizes \hat{ }40. In the up-sampling stage, all linearly up-sampled features are convoluted with the 3×3×1 kernel before being concatenated together. The class-wise probability: D×W×H×K∈[0,1] is obtained by another convolution of the assembled features. Thereby, the distance map Ψ:D×W×H∈{0, 1, . . . , K} can be easily derived from

$${Ψ}_{i} = arg {max}_{k} {P}_{ik} .$$

DMapNet was implemented with TensorFlow and Python. Inputs were randomly cropped from 54 volumetric stacks of the size of 134×205×285. Adam optimization with an initial learning rate of 5×10⁻⁴ was used to update parameters. By setting the batch size to 2, we trained the model for 5000 epochs on one NVIDIA 2080Ti GPU.
Watershed Segmentation with Automatic Seeding

Watershed segmentation is well suited for separating individual cells based on the distance map Ψ. Here, we propose an automatic seeding procedure to facilitate the cellular segmentation by detecting appropriate seeds from the membrane mask.

The Kth class in Y is regarded as the membrane mask Φ^{P}. By selecting the background as the target voxel, Euclidean distance transformation is applied to Φ^{P}, yielding M^{p}. All local H-minima in M\hat{ }P are denoted as S={sᵢ}_(i=1, . . . , L) where L is the number of local minima. A weighted graph G is constructed to cluster s_i's that belong to one cell or background. Edges E={E₁, E₂} in G come from two sources: one is the Delaunay triangulation on S, noted as E₁, and the other is the edges, E₂ among all local minima located on the boundary of the volume. The weight of edge e_ij is defined as:

$$W ( {e}_{ij} ) = \{ \begin{matrix}{\sum }_{( x , y , z ) ∈ {e}_{ij}} {ℳ}^{P} ( x , y , z ) , & {e}_{í j} ∈ {E}_{1} \\ 0 , & {e}_{i j} ∈ {E}_{2}\end{matrix} \vert$$

where (x,y,z)∈e_ij represents all points on the edge e_ij. One edge is removed from E if the corresponding weight is greater than the OTSU 69 threshold on W. Consequently, vertexes S were clustered based on their connectivity. As opposed to inspecting each minimum, we treated each cluster, possibly including multiple minima, as one seed. This group-seeded watershed transformation on M\hat{ }P reduces under- or over-segmentation errors.

### Cell Tracing and Identification

StarryNite and AceTree were used to automatically trace and assign identity of each nucleus by outputting nuclei positions and names. In CShaper, we leveraged these tools to name the segmentations described above. Generally, if one partition was associated with only a single nucleus, then the cell was named after the nucleus directly. However, at the beginning of cell division, two nuclei may coexist within one cell (enwrapped in the same membrane) during anaphase. In this case, the segmented region was named after the mother cell rather than the daughter cells. CShaper also defined a cavity inside an embryo when a partition was empty with no nucleus inside.

### Standardization of Embryo Samples

After linear normalization of the 46 embryos (Samples 04-49) as per the previously proposed pipeline, which consists of consecutive rounds of rotation (60 cycles), translation (60 cycles), and scaling (30 cycles) in x, y, and z axes to minimize the global positional variation between embryo samples \hat{ }9, four operations were subsequently carried out to establish a standard morphological atlas with normalized embryo size and orientation. First, a translation in the yz plane and rotation around the x axis was performed sequentially on the 17 embryos that expressed the membrane marker (Samples 04-20), which ensured that the focal planes of the first and last confocal images were parallel to the xz plane and distributed symmetrically on both sides of the xz plane. Second, a translation in the xz plane and rotation around the y axis were performed sequentially on the same embryos to keep their projection on the xz plane embedded by a centralized ellipse with the minimum area. Third, all 17 embryos were rescaled to their average size in the three orthogonal directions. Finally, the remaining 29 embryos labelled with only the nucleus marker (Samples 21-49) were linearly normalized to the average cell positions of the 17 embryos using the same loop algorithm composed of rotation, translation, and scaling.

### Definition of Effective Cell-Cell Contact

The following empirical criteria were used to establish effective contact between specific cells with potential biological relevance:
1. Contact area: a contact area is not < 1/48 of a cell's surface area. This area threshold is expected to be large enough for functional intercellular communication based on theoretical modeling. It is well known that each sphere is surrounded by 12 neighbors in a close-packed structure of equal-sized spheres, which in theory has the highest space occupancy and system stability. In the C. elegans embryo, the radius ratio between neighbor cells can reach up to 3:1). Thus, based on the hexagonal close-packed structure, we estimated the cell-cell contact area threshold by simulating how many cells with a radius ratio of up to 1/3 can be accommodated within space formed by a unit cell with a radius of 1. As a uniform neighbor cell can be replaced by, at most, four smaller cells with a radius ratio of 1/3, the relative contact threshold was set as 1/12×¼= 1/48.
2. Contact duration: a contact duration is no shorter than 3 min, i.e., two consecutive time points. This threshold was previously found to be satisfied by all the cell pairs with known Notch signaling in C. elegans.
3. Reproducibility: a contact is reproducible in all 17 embryos. As we focused on cell-cell contact necessary for normal development, reproducible contacts found in all samples were assumed to have the highest possibility of being functional. This requirement (100%) is high because the contact relationship obtained based on the membrane morphology is expected to be more reliable than that inferred from the nucleus position.

### Example 2

### Benchmarking of Segmentation Results

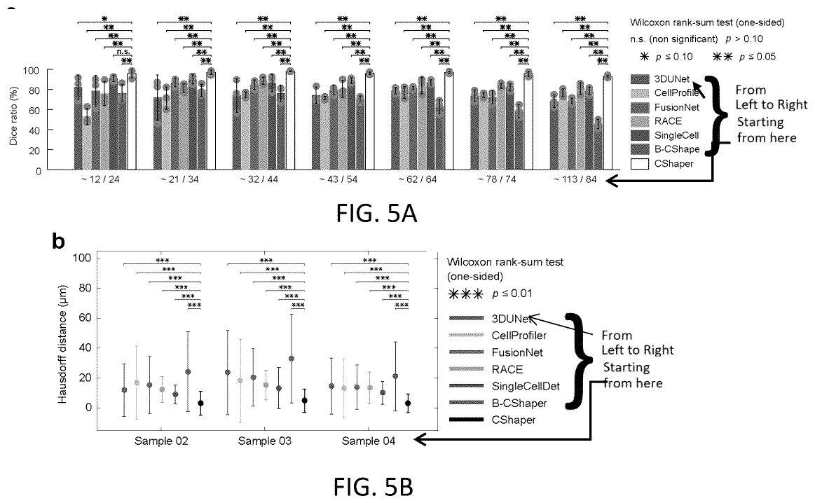

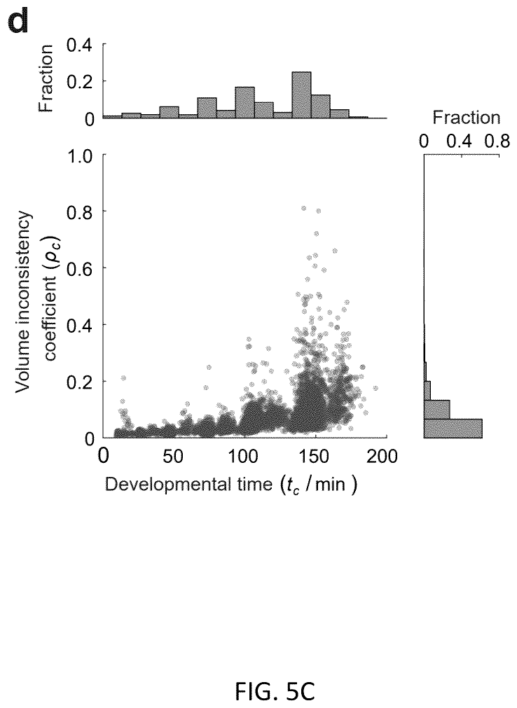

The method of the present invention was compared with other methods in cell segmentation, including 3DUNet, SingleCellDetector, FusionNet, RACE, and CellProfiler. To allow a fair comparison, watershed algorithms were appended as a postprocessing procedure for 3DUNet and FusionNet where only binary membrane segmentation is available. A variant of the system of the present invention (CShaper) termed B-CShaper was tested to examine the superiority of the distance-constrained learning used by CShaper to the binary classification in B-CShaper. FIGS. 5A, 5B, and 5B show the results of this comparison. FIG. 5A is a graph showing the dice ratio, as a pixel-level score, widely used to measure the similarity between computational segmentation results and the ground truth. After testing embryos at different cell stages, the present invention obtained a score of 95%, outperforming other methods by a significant margin. Therefore, in terms of the overlapped volume criteria, the segmentation results of the present invention were highly consistent with manual annotations.

### CShaperApp

CShaperApp is an efficient and scalable computer-based application for researchers in developmental biology, facilitating the exploration of fine-gained quantitative cellular morphological data in a developing embryo. Promisingly, such an integration of CShaper simplifies routine tasks in processing large-amount microscopic images. Owning to the flexibility of modularized implementation, this open-source tool can be easily optimized by replacing the integrated segmentation model with the more advanced ones.

To improve the usability of CShaper to this community, in this work, a desktop software CShaperApp is developed as part of one embodiment that interactively performs image segmentation and morphological analysis. Modular functions of CShaperApp allow researchers to either adaptively retrain CShaper with their own dataset or process external datasets with the pre-trained model. The codebase is publicly available and can be easily modified for other animal organisms.

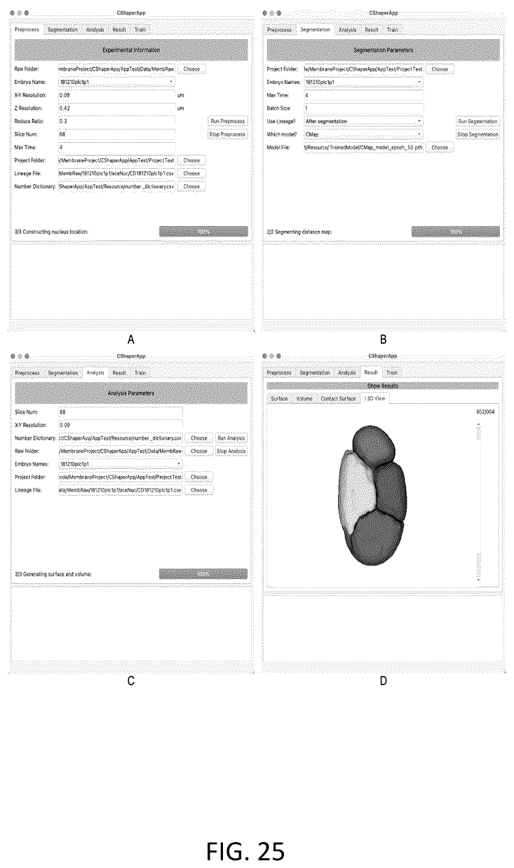

CShaperApp was developed with TensorFlow and PyQt5. To increase the flexibility of CShaperApp, the workflow was decomposed into a series of modules. Each module can be executed independently according to the requirements of different tasks. Specifically, CShaperApp consists of five modules, Preprocess, Segmentation, Analysis, Result, and Train. The Preprocess module stacks all microscopic slices at each time point into one volumetric image (FIG. 25A).

FIG. 25 is a diagram that shows the graphic user interfaces of a CShaperApp according to an embodiment of the present invention consists of five functional components: (FIG. 25A) Preprocess, (FIG. 25B) Segmentation, (FIG. 25C) Analysis, (FIG. 25D) Result, and Train for model retraining adapted to different datasets.

When the cell position and lineage file, generated from StarryNite and AceTree, is available, the cell (nucleus) position information is extracted to synthesize binary nucleus masks where foreground pixels correspond to the centers of the cell nucleus. The Segmentation module adopts the CShaper framework to segment fluorescence images of cell membranes, transforming them into digitized segmentations with clear identification of the region corresponding to each cell (FIG. 25B). The Analysis module automatically collects cellular morphological features such as cell volume, cell surface area, and cell-cell contact area, in the format of Excel (FIG. 25C). The Result module provides the visualization of segmented cellular morphologies while showing all statistical information as well. Particularly, the segmented 3D embryo is shown with each cell labeled in different colors (FIG. 25D). Users can apply quality control to statistical data to filter out confident results. The Train module allows users to retrain the model based on a specific dataset to deliver optimal results.

The modular pipeline allows users to work on the data flexibly. For example, the Preprocess and Segmentation modules are still executable even when the cell position and lineage file are unavailable, alleviating hands-on time as users may be only interested in the overall cellular morphological changes regardless of cell identity. The integration of Train module enables researchers to optimize models using their own data in new application scenarios. CShaperApp can be executed on Windows, Linux, and MacOS, and all parameters used in different modules are configurable through user interfaces. Exemplary datasets, along with detailed usage guidelines, are available online for users to test and improve the performance of CShaperApp.

Computational efficiency and segmentation accuracy are two of the most important aspects in evaluating the performance of cellular segmentation software. In one embodiment of the present invention is adapted to evaluate the computational efficiency with the time-lapse images. For segmentation accuracy, one embodiment is adapted to apply CShaperApp to the image datasets, which were captured from different equipment at various spatial resolutions. These numerical experiments could faithfully demonstrate the robustness of the program, thereby ensuring its reliability in a wide range of practical application scenarios.

The tested sample from the CShaper dataset includes 150 time points (covering the 4-cell to 350-cell stages) with a temporal resolution of 1.39 minutes; the axial (z) resolution is 0.09 μm and the lateral resolution (xy) is 0.42 μm. To segment these time-lapse images, the Preprocess module first stacks all 68 slices at each time point together; then the volumetric image is resized from 512×712×68 to 153×213×95 with an isotropic spatial resolution of 0.30 μm. The Segmentation and Analysis modules are subsequently applied to get the final cellular morphological features. For a workstation with Intel® Xeon CPU and NVIDIA GPU 3090, it costs about 30 minutes in total to finish all the tasks. We recommend users refer to the online document for specific usage guidelines, in particular to the file structure and data format.

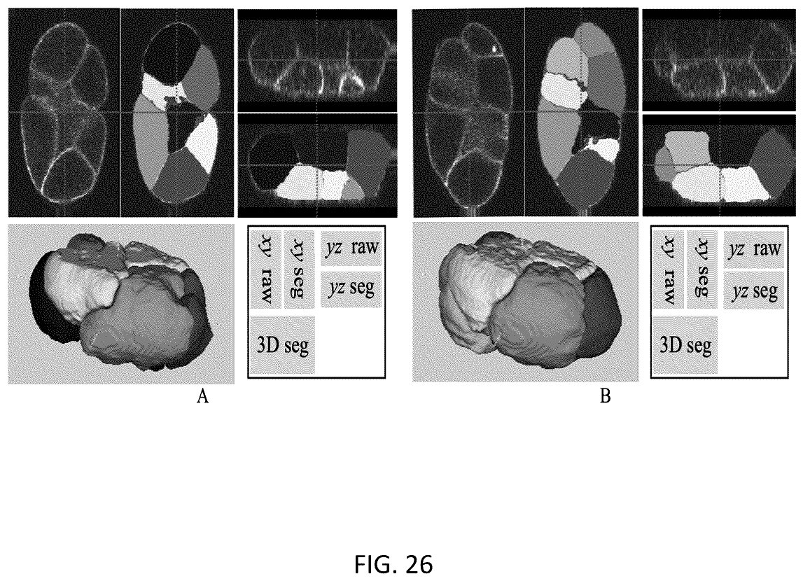

Furthermore, the embodiment of the present invention is adapted to use data in the spheresDT/Mpacts-PiCS dataset to verify whether CShaperApp is applicable to data from other laboratories. The imaging data has a lower axial resolution than that used in CShaper (1.20 μm versus 0.42 μm), making it challenging for the pre-trained model to recognize cell regions correctly. In one embodiment, the system is adapted to utilize the Train module to retrain the model with 8 pairs of images and annotations, helping the deep learning model adapt to the specific data distributions. In one experiment, the retrained model delivered promising results as shown in FIG. 26. To sum up, the experimental result demonstrates the adaptability of CShaperApp to lower-resolution images.

FIG. 26 is a diagram that shows experiment results on the dataset from spheresDT/Mpacts-PiCS. Two cell segmentation examples of “TL2_2_t2-6” processed with CShaperApp according to an embodiment of the present invention in (FIG. 26A) and (FIG. 26B), respectively. For the inset on the bottom right of both the left and right panels, “xy” and “yz” represent the direction of the observed cross-sections, while “raw” and “seg” indicate the raw and segmented images, respectively.

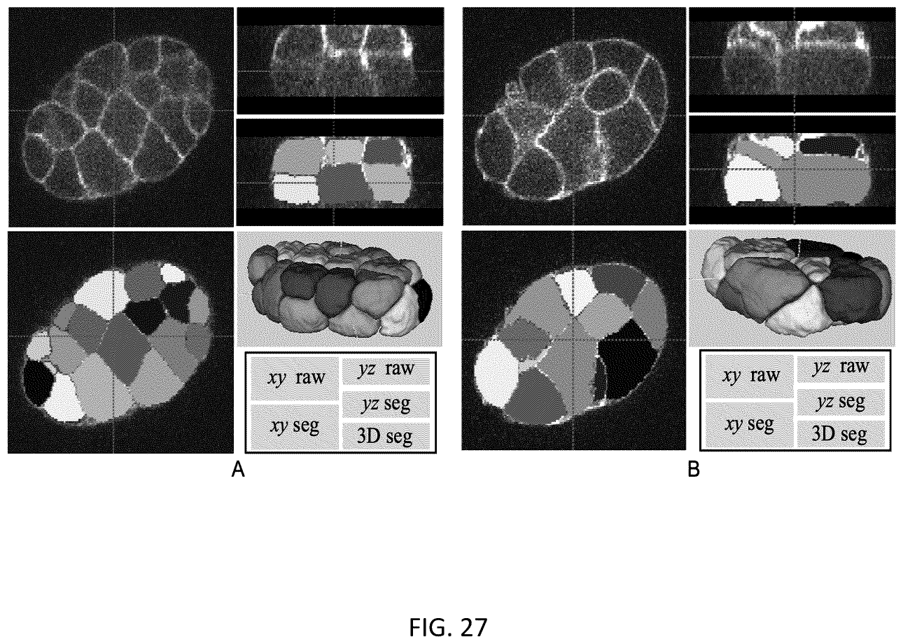

Although fine-tuning the deep learning model is favorable, users may face the problem of lacking annotated data for training. To investigate the scalability of CShaperApp, one embodiment of the present invention is adapted to utilize the previously trained model to process the data from Biologically constrained optimization-based cell membrane segmentation in C. elegans embryos (BCOMS) directly. The data from BCOMS is imaged at almost isotropic spatial resolutions (axial resolution: 0.50 μm; lateral resolution: 0.44 μm) but its lateral resolution is lower than those of both CShaper and spheresDT/Mpacts-PiCS. Without any bells and whistles, CShaperApp still preserves high performance on this dataset (FIG. 27). The scalability of CShaperApp allows users to leverage off-the-shelf tools in customized workflow.

FIG. 27 is a diagram showing experiment results on the dataset from BCOMS. Two cell segmentation examples at the 12- and 24-cell stages processed with CShaperApp in (FIG. 27A) and (FIG. 27B), respectively. For the inset on the bottom right of both the left and right panels, “xy” and “yz” represent the direction of the observed cross-sections, while “raw” and “seg” indicate the raw and segmented images, respectively.

CShaper treats a cluster of local minimums as seed in watershed segmentation, allowing for the detection of cavities among cells. However, it becomes challenging for CShaper to correctly recognize cells when the embryo develops into late stage.

In one embodiment CMap is integrated to CShaperApp as one of the optional models for specific purposes. Users may accordingly switch the segmentation model from CShaper into CMap so that low-quality images can be better segmented by incorporating nucleus information. Specifically, there is no significant difference between CShaper and CMap before 100-cell stage, however, CShaper retains the superiority in detecting cavity. Therefore, CShaper is particularly suitable for segmenting images before 100-cell stage in this integrated system. Additionally, modular design enables developers to reuse other components and reduce development costs.

### CTransformer

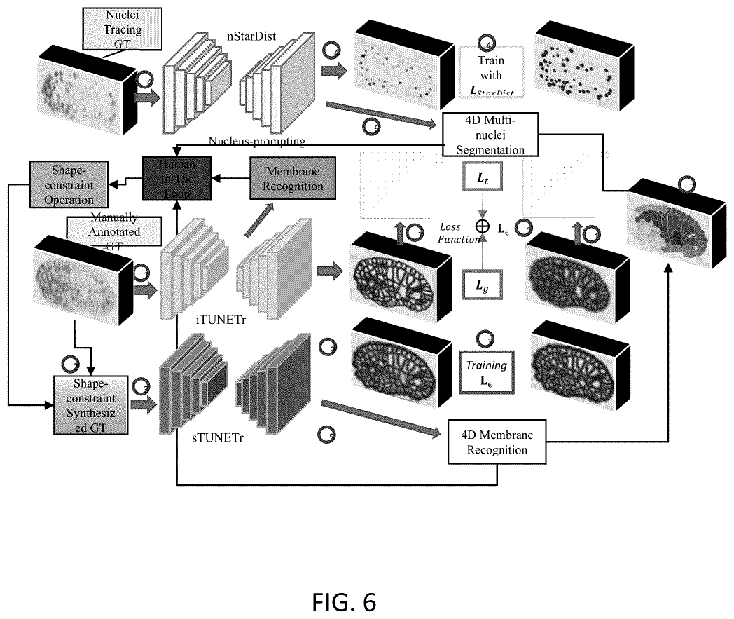

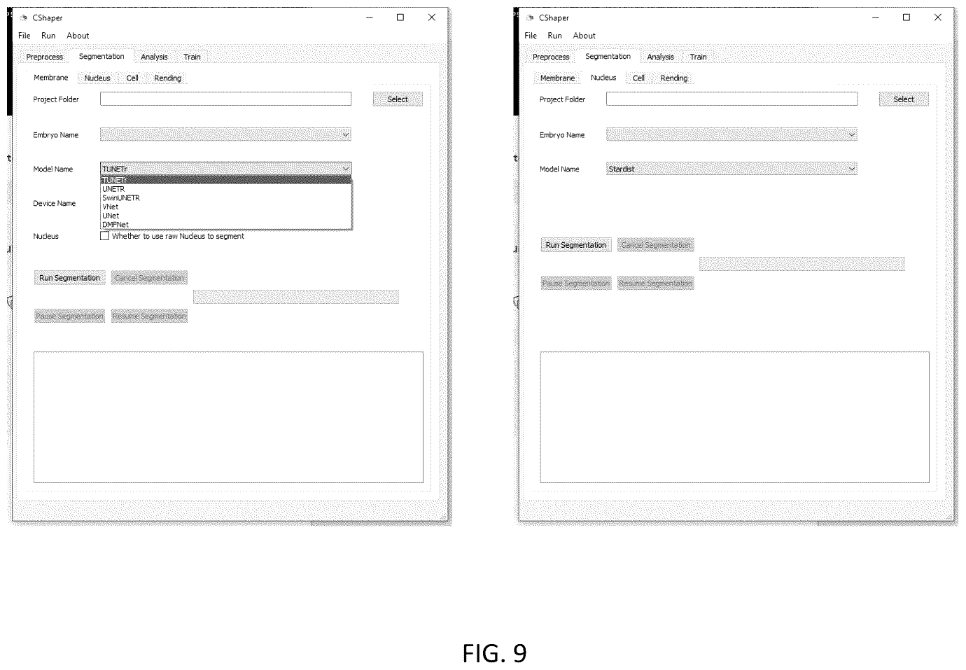

Another variant of the system of the present invention, CTransformer is implemented for establishing cellular segmentation in live-cell embryonic images. Referring to FIG. 6, there is provided a comprehensive generalizable and adaptive integrated Deep Neural Network (DNN)) pipeline for 4D image cellular segmentation, termed CTransformer. As shown in FIGS. 6 to 11, there is provided a schematic diagram of the CTransformer of an embodiment of the present invention. The CTransformer is based on encoder-decoder DNN structure. The Swin Transformer Block module deploys an attention mechanism in the DNN.

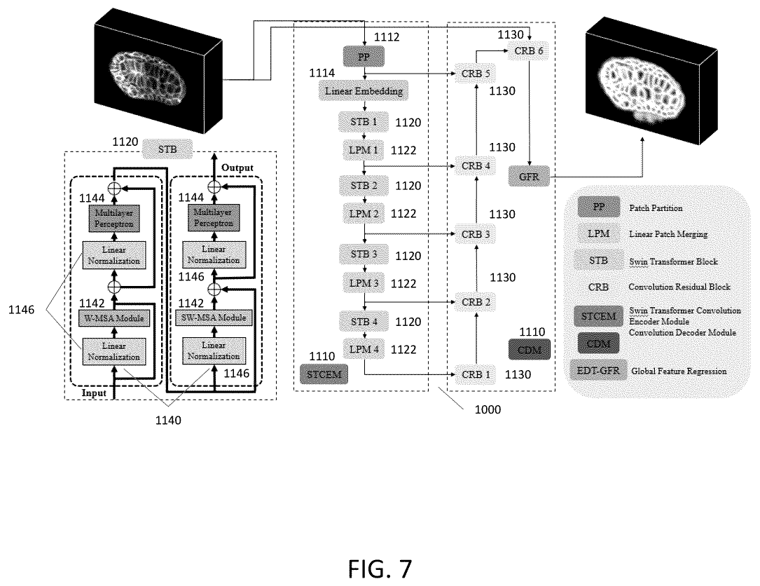

In one embodiment, the CTransformer architecture 1000 is presented in FIG. 7, which comprises an Encoder Module 1100 such as a Swin Transformer Convolution Encoder Module for encoding the image data and a Decoder Module 1110 such as Convolution Decoder Module (CDM) for reconstructing a segmentation mapping. The Encoder Module 1100 comprises a Patch Partition layer 1112 and Linear Embedding layer 1114. The Patch Partitioning layer 1112 takes the input image and splits the input image into non-overlapping patches. Each patch is treated as a “token” and its feature is set as a concatenation of the raw voxel or pixel values. The Linear Embedding layer 1114 A is adapted to project raw voxel or pixel valued features to an arbitrary dimension.

Multiple Swin Transformer blocks 1120 (STBs) and Linear Patch Merging (LPM) layers 1122 are applied to these patch tokens. To produce a hierarchical representation, the number of tokens is reduced by each Linear Patch Merging Layer 1122 as the network gets deeper. In one embodiment of the present invention, there are four sets of transformation procedures, wherein each transformation procedure has a Swin Transformer Block 1120 followed by a Linear Patch Merging Layer 1122. Each time when a LPM layer is applied, there is a reduction in the number of tokens. After four sets of transformation procedures, the data is passed to the Decoder Module 1110. The Decoder Module 1110 comprises six sets of Convolution Residual Block 1130 (CRB). Each CRB 1130 takes an output from a corresponding layer in the Encoder Module 1100 and added to an output from a previous layer of the Decoder Module 1110 as shown in FIG. 1. In the final step, the Decoder Module 1110 passes the data to a Global Feature Regression (GFR) Module 1132 to generate the segmentation mapping and the morphological atlas of the embryo. In one embodiment, the GFR utilizes Euclidean Distance in the regression to generate the morphological atlas of the embryo.

In one embodiment of the present invention as shown in FIG. 7, each of the STB 1120 comprises one or more consecutive Transformer Blocks 1140. Each Transformer Block comprises a shifted window based multi-headed self-attention (MSA) module 1142 and a Multilayer Perceptron 1144 (MLP). A Layer Normalisation (LN) layer 1146 is applied before each MSA module and MLP, and a residual connection is applied after each module. In one preferred embodiment, the MLP 1144 is a 2-layer multi-layer perceptron with Gaussian Error Linear Unit (GELU) nonlinearity in between

CTransformer incorporates a topology-aware loss into large vision model, simultaneously boosting the training process with human-in-the-loop annotation strategy. Self-attention module for recognizing invisible membrane signals, this membrane segmentation procedure significantly pushes the fluorescence segmentation limit further, to unseen developmental periods and imaging conditions. This pipeline has been experimented on C. elegans embryos for evaluation CTransformer on time-lapse GT and demonstrated that this method can recognize cell membranes under diverse imaging conditions and across various embryonic development stages, reaching better accuracy, robustness, and generalization capabilities than other existing methods.

The DNN model of CTransformer is also referred to as a semi-supervised Topology-constraint U-shape Nucleus-prompting Euclidean distance transform Transformer (TUNETr). To make sure that TUNETr performs well with a few training GTs, TUNETr integrates the relative positional attention mechanism of transformers25, prior inductive bias knowledge and image processing technologies in a U-shaped network, topology-constraint loss function. CTransformer also utilizes edge-enhancing semi-supervised learning and synthetic GT to solve the above-mentioned challenge in failure of segmenting axial and unseen images. Moreover, in one embodiment of the present invention, there is provided a nucleus-prompting module to provide another stream merged with the membrane recognition to provide double guarantee for cell centroid identification and avoid chain errors. In one embodiment of the present invention these complicated modules are grouped together to build a human-in-the-loop pipeline to simplify the 3D volume annotation, which closes the gap between segmentation of AI and the human-level cell-wise annotations. To experimentally evaluate the performance of CTransformer for live-cell embryos, we applied the segmentation on C. elegans, imaged and annotated by biological experts, under different imaging conditions, from very vague to relatively clear. This membrane segmentation procedure evaluates the in vivo embryos from multiple metrices with existing other DNN methods on a great number of time-lapse 3D cellular wild data and demonstrates the significant outperformance of the proposed pipeline. Thereafter, a complete study to showcase the potential of CTransformer for 4D in vivo cellular segmentation has been carried out. Additionally, CTransformer generated pseudo nuclei images from the cell morphology map, which allows cell lineage tracing from only membrane fluorescence images. A user-friendly interface is developed for recognizing, segmenting, and building a living embryonic cell atlas with multiple DNN models and allows researchers to visualize the 4D cell shape and contacting features in ITK-SNAP-CVE. This embodiment of the present invention provides a high-precision segmentation, time-lapse visualization, and morphological analysis of live late-stage embryos feasible and efficient.

Following a different CTransformer implementation of an embodiment of the present invention. The segmentation can be carried out by one or more of the following CTransformer:
a) The basic deep learning model is the transformer-based regression network (EDT-Swin-UNETR).
b) topological loss (EDT-Swin-UNET R+TL—trained model called iTUNETr at the previous subsection),
c) semi-supervised shape-constraint (EDT-Swin-UNETR+TL+SC-SL—trained model called sTUNETr in other sub-section).
d) nucleus-prompting seeds (EDT-Swin-UNETR+TL+SC-SL+NPS—the last TUNETr).

The CTransformer, is the entire computational pipeline for cellular segmentation and establishing cell morphology map. This architecture integrates both deep neural network (DNN) components and specialized algorithms to create an end-to-end solution for 4D membrane recognition. TUNETr is the core DNN within the CTransformer framework, designed for pixel-wise membrane recognition. iTUNETr is the initial pre-trained DNN with 71 manually annotated 3D images. Building upon iTUNETr, sTUNETr undergoes additional fine-tuned on the synthetic, edge-enhanced and pseudo-annotated GT. This fine-tuning process incorporates topology priors, significantly refining the DNN's ability to discern accurate membrane structures and cellular segmentation. The operational flow starts with iTUNETr for basic 3D membrane identification, which then progresses to STUNETr for advanced 4D segmentation, leveraging semi-supervised learning to enhance model generalization and accuracy with human-in-the-loop nuclei hints. This progression ensures precise membrane recognition and cell segmentation across various developmental stages and imaging conditions.

### Detailed Workflow of CTransformer

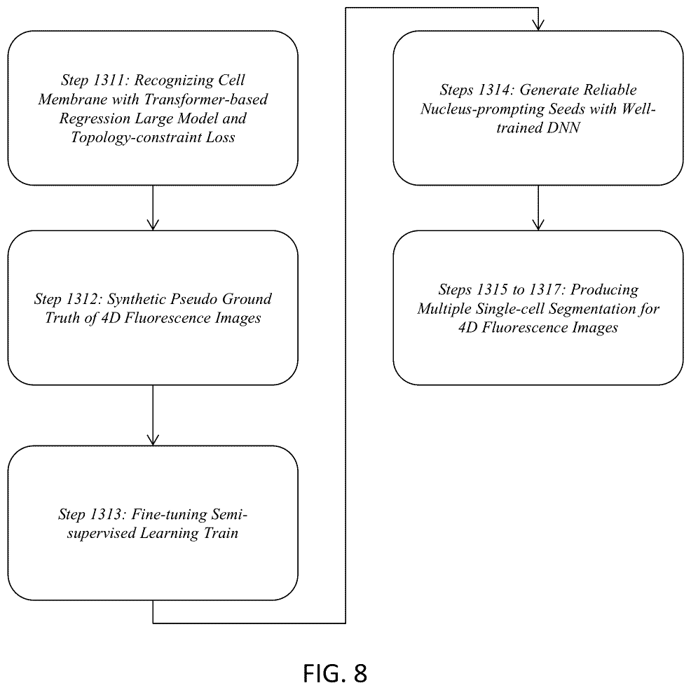

In one embodiment of the present invention as shown in FIG. 8, the CTransformer process 1000 comprises a computer executable program adapted to execute in a system described in a system 100 as shown in FIG. 1. The CTransformer process 1000 comprises the steps of:
Step 1311: Recognizing Cell Membrane with Transformer-based Regression Large Model and Topology-constraint Loss;
Step 1312: Synthetic Pseudo Ground Truth of 4D Fluorescence Images
Step 1313: Fine-tuning Semi-supervised Learning Train;
Step 1314: Generate Reliable Nucleus-prompting Seeds with Well-trained DNN; and
Steps 1315 to 1317: Producing Multiple Single-cell Segmentation for 4D Fluorescence Images.
   Step 1311: Recognizing Cell Membrane with Transformer-Based Regression Large Model and Topology-Constraint Loss.

In the initial phase of the method in accordance with an embodiment of the present invention, as outlined in (step 601 of FIG. 6), it is established that a ground truth (GT) dataset comprises manually annotated images 610, like other DNN. These annotations represent a range of embryonic developmental stages and imaging conditions. This GT dataset serves as the foundation for training DNN, TUNETr, within CTransformer, resulting in a pre-trained iTUNETr 620 network, with 71 volumes in this study. In one embodiment, it utilizes the capability of large DNN, TUNETr, convoluting voxels of 3D volumes with the neighboring voxels (self-attention). So, iTUNETr 620 facilitates the precise identification of voxels that were previously indistinguishable due to extremely weak signals, noises and various artifacts. Consequently, the recognition results in seen conditions (similar raw images in the GT) are granted by the DNN (iTUNETr 620).

With pre-trained iTUNETr 620 in one embodiment, there is introduced a topology loss term, Lₜ (step 601 in the right of FIG. 6), in the further training. Pretrained iTUNETr 620 is necessary since the topology loss can only be accurately computed with the context of a relatively correct spatial shape (cellular). This improved loss function is an enhancement of a geometric loss term, L_{g} (step 601 in the right of FIG. 6), being effective in constraining single cell's topological structure in the same as the GT. This represents a minor adjustment to the initial model iTUNETr, from a higher-dimensional perspective (topological latent space).

There are two ways to annotate the membrane for recognition. One approach starts from scratch, relying solely on human visual inspection to annotate images on each 2D slice and then observing in 3D to check if the annotations across different slices are continuous and credible. These annotations are voxel-wise accurate but are subject to variability due to different annotators' standards and encounter issues with discontinuity in 3D. Another approach involves modifying, directly, on the 3D results by trained DNNs. However, this can lead to issues where pre-recognized volumes influence human judgment, as some areas in the raw volumes are not absolutely clear even with human annotation. So, we use both approaches to manually annotate the GT for training, to discard the dross and to select the essence. Here, we get the “specialist” DNN, iTUNETr.

### Step 1312 and Step 1313: Synthetic Pseudo Ground Truth of 4D Fluorescence Images and Fine-Tuning Semi-Supervised Learning Train

In one embodiment, the “specialist” DNN is trained, using manually annotated GT, to recognize the membrane (semantic segmentation) for fluorescence 3D images. To obstacle the biggest drawback of DNN, lacking generalization ability and only working at a special task, also for transformer based large model, a substantial synthetic pseudo GT and semi-supervised learning scheme that cooperates with human intervention is made for one embodiment of the present invention.

The iTUNETr model recognizes cell membranes in anisotropic raw fluorescence images, achieving an accuracy comparable to human annotation level for seen imaging conditions. To amass a large GT dataset while maintaining a human level of accuracy, TUNETr allows users to manually adjust the center of cell shape. This human-in-the-loop step provides location prompts and eliminates irrelevant surroundings from the recognition area, refining the membrane recognition to reasonable positions and sizes. Users can repeatedly tune the prompts and select the correct membrane recognition volumes to form the synthetic pseudo GT, integrating it with the manually annotated GT (step 602 of FIG. 6). These new GT membrane annotations are constrained from real cell shape, and the embryos' edges are tripled in thickness, for dragging DNN's attentions to the weak imaging area.

This user-customized synthetic pseudo GT encompasses a vast of unlabeled data, covering all imaging conditions (both seen and unseen, labeled and unlabeled) relative to the task. Then, restoring from iTUNETr, adjusting the DNN parameters, and proceeding with training (step 603 of FIG. 6), TUNETr generates a “generalist” DNN, STUNETr 622 (semi-supervised TUNETr, akin to iTUNETr), tailored for specialized tasks under unseen imaging conditions, such as those with significant artifacts or in late developmental stages.

Step 1314: Generate Reliable Nucleus-Prompting Seeds with Well-Trained DNN

In a preferred embodiment, there is provided a nucleus-prompting step to keep chain and serious cell shape segmentation errors away (step 604 of FIG. 6). Informed by nucleus cues, TUNETr avoided completely erroneous segmentation in extremely ambiguous imaging areas. This step helps in constructing potent cell instance generation (multi-cell segmentation) algorithm from cell membrane recognition. Due to the deep learning model being a global and customized method, the recognition of top and bottom areas (axially upper and lower) in the volumetric images still failed when the imaging conditions were very different, or the trained model had not “met” before (in the training data). Fortunately, nucleus images are relatively clear and easy to detect as nucleus instances. Thus, the present invention can significantly improve the robustness of DNNs, including TUNETr, DMFNet, etc.

### Step 1315 to Step 1317: Producing Multiple Single-Cell Segmentation for 4D Fluorescence Images

At the final processing steps (steps 605 to 607 of FIG. 6), the embodiment of the present invention runs the segmentation on a number of embryos (in one example, 34 embryos), providing an error-free dataset for fluorescence images processing and relative biomedical studies. Integrating the large training set and sTUNETr 622, an embodiment of the present invention is able to generate a more convincing cell morphology map.

In one embodiment of the present invention, there is provided an interface software and corresponding website for this 4D cellular segmentation map, also compatible with the visualization database website (CMOS) and analysis software (ITK-SNAP-CVE)^{3,6}. The running multiple cell segmentation program, the interface software is relatively friendly to non-programmers, biologists and physicists. Therefore, for different multicellular organisms, including C. elegans, TUNETr system can directly generate 4D data that can be traced back to the cell shape level, which can greatly promote the study of cell morphology in the embryonic development process.

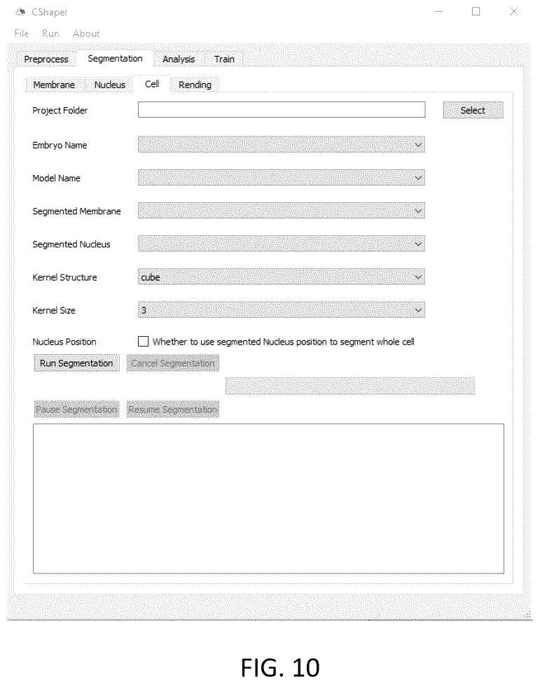

In one embodiment of the present invention as shown in FIG. 10, there is provided a software interface for researchers to run the segmentation, cell shape analysis and visualization without coding or configuring GPUs.

In a preferred experiment, 4D fluorescence images for in vivo embryos, also described as 3D+t data, are imaged on a confocal microscope equipped with multiple detectors using resonance scanners.

In one embodiment, the 4D Fluorescence Images and Cell Identities Acquisition in the Step of receiving a plurality of 3D images of the embryo representative of the morphological process of embryonic cells from a first predetermined cell population to a second predetermined cell population.

In one embodiment, there is provided optical imaging of 22 compressed (2 mutants) and 12 uncompressed (4 mutant) individual C. elegans embryos up to 350-cell stage, using GFP to label cell nuclei (with laser beam 488 nm) and mCherry for cell membrane (with laser beam 594 nm) imaging data. These time-lapse flat-mount fluorescent images, affixed to a glass slide with polylysine, were generated from the ZZY0637 and ZZY0655 strains on NGM (Nematode Growth Media) plates. The embryos were seeded with OP50 and kept at room temperature, 20 to 25° C. In the imaging, the temporal resolution was 1.39 to 1.45 min per frame, and the volumetric spatial resolution was 0.18 or 0.25 (0.18³ or 0.25³ μm³ per voxel). All imaging began at the 4-cell stage of each embryo and 18 embryos after the 350-while the other 20 embryos after 550-cell stage. Moreover, images were captured using either the SP5 II or Stellaris confocal microscopy system from Leica. The images were then processed and analyzed using the LAS X software from Leica and ImageJ. To keep the animal embryos alive, the tense of light is fitted to low (a scanning speed of 8000 Hz with a water immersion objective), which would cause severe light scattering and laser attenuation at the late time. The imaging process was segmented into different time blocks, corresponding to 60 time points interval. The z-axis compensation ranged from 0.5-3% for 488 nm and 20-95% for 594 nm laser. Prior to the recognition and segmentation of the images, they underwent a deconvolution process.

With software AceTree and StarryNite, every cell nucleus (cell identity, i) at different time points (time index, t) in each embryo (individual, j) was recognized and traced. The cell nuclei are recorded in the position x_{i,j,t}, y_{i,j,t}, z_{i,j,t}, and every cell in a 3D multi-cell segmented embryonic volumes j, t could be named to a cell identity i using the traced cell nucleus. From multi-cell segmentation of 4D fluorescence images, these nuclei tracing results allow TUNETr to produce manually annotated level synthetic GT and the following shape-constraint semi-supervised learning.

### Transformer-Based Large Model

The TUNETr proposed in the present invention, is a UNet-like Swin Transformer deep learning neural network for 3D+t cellular membrane recognition. Contracting images to high-level spatially relative feature maps, TUNETr consists of a stack of transformers as the encoder. Embedding 1D sequence input from a volumetric image, TUNETr partitions a 3D image x∈R^{(H×W×D)} into

$$N = \frac{H \times W \times D}{h \times w \times d}$$

one-dimensional (1D) sequences, x_{ν}∈R^{(h×w×d×C)}, also named patches or tokens, which represent a word in transformer of NLP. Here, (H, W, D) and (h, w, d) denote the resolutions of the 3D image and each patch, and C is the number of embedding space of feature map (feature size). Self-attention computation is conducted in non-overlapped (h×w×d×C) patches (tokens) and the small-sized patches for reasonable computational complexity but it has no communication with other patches while losing global attention. To obtain significant global attention in density prediction, TUNETr applied the shifted window based self-attention in the volumetric semantic segmentation. One window (layer l) contains (M, M, M) patches evenly in N patches from a 3D image, and the next layer l+1, is shifted with

$$( \frac{M}{2} , \frac{M}{2} , \frac{M}{2} )$$

voxels. The previous and subsequent shifted windows, layer l and l+1, both containing M×M×M patches, with window based multi-head self-attention (W-MSA) and shifted W-MSA (SW-MSA), is calculated by

$${\hat{z}}^{l} = W - MSA ( LN ( {z}^{l - 1} ) ) + {z}^{l - 1} , {z}^{l} = M L P ( L N ( {\hat{z}}^{l} ) ) + {\hat{z}}^{l} , {\hat{z}}^{l + 1} = SW - MSA ( LN ( {z}^{l} ) ) + {z}^{l} , {z}^{l + 1} = M L P ( L N ( {\hat{z}}^{l + 1} ) ) + {\hat{z}}^{l + 1} ,$$

where the \hat{z}^{l} and \hat{z}^{l+1} denote the outputs of W-MSA and SW-MSA modules, providing cross-window (global attention of one volume) connections. Multilayer perceptron module (MLP) convolutes the data to a target resolution (number of channels) and linear normalization module (LN) avoids the vanishing and exploring gradient problems. TUNETr also utilizes cyclic and reverse cyclic shift in masking and padding the hierarchical window partitions for efficient self-attention calculating without messing up the original image order. To keep the significant spatial inductive bias, self-attention is calculated by Attention (Q, K, V)=Softmax (QK^{T}/\sqrt{b})V, where Q, K, V∈R^{(h×w×d×b)} are the query, key and value metrices in transformer, and b is the query/key resolution.

The encoder of TUNETr sets (h, w, d) of each patch as (2×2×2) and a patch length is 2×2×2×2=16, with 2 nucleus and membrane channels of the 3D volumetric images. With raw input 3D image x∈kicked me ^{(128×128×128)}, the feature size of embedding space C as 48, and depths of 4 stages as (2, 2, 2, 2) Swin Transformer Blocks (respectively 8 W-MSA and SW-MSA modules), TUNETr encoder processes the input x∈R^{(128×128×128×2)} as following stages (Swin transformer block): (64, 64, 64, 48), (32, 32, 32, 96), (16, 16, 16, 192), (8, 8, 8, 384), (4, 4, 4, 768). Here, keeping explainable hierarchical and consistent with UNet, a patch merging module reduces the spatial resolution by 2 while the channel number would be embedded and increased by 4, and a linear convolutional neural layer reduces channel number by 2 for output of each stage (Swin Transformer Block).

The corresponding decoder integrating residual layers, increasing the resolution of feature maps, and receiving skip connections from stages of encoder, the upper data flow from high level to low level semantic (understandable) feature map denotes as: (8, 8, 8, 384), (16, 16, 16, 192), (32, 32, 32, 96), (64, 64, 64, 48), (128, 128, 128, 48). The output feature map at the bottleneck is fed into a convolutional layer and an Euclidean distance transform global regression module (EDT-GFR) for cellular membrane recognition (prediction of probabilities of voxels being cell membrane).

### Topological Wasserstein Distance Loss

Transformer (attention module) deep neural network solves the local features learning problem. However, the existing loss functions in voxel-wise recognition (segmentation), like the binary cross entropy (BCE), mean square error (MSE), and soft Dice score loss in VNet, are not coherent to regularizing the cellular boundary and have no receptive field in global 3D images. To drive the network to not only geometrically accuracy but also cellular shape level correct, we propose a topology-constraint loss integrating EDT, persistent homology (PH), and p-Wasserstein distance. The proposed loss includes 2 parts: geometrical L_{g} and topological loss Lₜ:

$${L}_{ϵ} ( {Y}_{pred} , {Y}_{g t} ) = {L}_{g} ( {Y}_{{pred}^{}} , {Y}_{g t} ) + {w}_{ϵ} \times {L}_{t} ( {Y}_{p r e d} , {Y}_{g t} ) + ξ ,$$

where the ϵ representing the current training epochs, Y_{pred} and Y_{gt}∈R^{(H×W×D)} are the predicted and ground truth cell membrane volumes respectively, and W_{ϵ} is the weight of topological loss according to the training epochs. ξ is the necessary constant term for all loss functions. The geometrical loss is calculated by MSE: L_{g}(y_{pred}, y_{gt})=Σ|μ_{(h′,w′,d′)}−ν_{(h′,w′,d′)}|, where μ_{(h′,w′,d′)} and ν_{(h′,w′,d′)} are respectively the probabilities of every voxel in y_{pred} and y_{gt}. Topological information and features can be extracted and learned by the TUNETr when the prediction is closed to the ground truth, so the geometrical loss is the main loss in L_{ϵ} at the initial training part. We is a consistent weight for topological loss depending on the complexity of the images (the number of topological structures).

Lₜ from cubical persistent homology (PH) diagram D, is calculated to extract topological structural differences of the prediction and ground truth 3D images (Euclidean distance transformed). For the volumetric images, they would be transformed to cubical complexes for representing images in a set of vertices, edges, facets and other higher-dimensional counterparts, which are basic topological elements. PH, is counting the number of p-dimensional topology structures (βₖ), also known as kth Betti numbers in D_{pred}^{(k)} and D_{gt}^{(k)}, including the birth and death time of βₖ (ref the PH showing figures), in the probability map. In the 3D space, there are 3-dimensional topological features, β₀, β₁, β₂ are the number of connected components (1D), holes (2D) and hollow voids (3D, the similar 3D structure in torus). The PH diagram is defined as D=Σₖ₌₀^{p}D^{(k)} of an image.

Wasserstein distance is optimal transport(ation) or the Monge-Kantorovich problem assessing the path, “difference” and distance from persistent homology diagram D_{pred} of Y_{pred} to D_{gt} of Y_{gt}. Lₜ is derived from p-Wasserstein distance between probability maps (p=3 for 3D images) with stability to noise:

$${W}_{p} ( {D}_{pred}^{( k )} , {D}_{gt}^{( k )} ) = {( {inf}_{η : {D}_{gt}^{( k )} \to {D}_{pred}^{( k )}} {\sum }_{x ∈ {D}_{g t}^{( k )}} ‖ x - η ( x ) ‖ )}^{1 / p} ,$$

where η(x) denotes a bijection from D_{gt} to D_{pred}. D_{gt} and D_{pred} have different βₖ, the bijection denotes to that the points of D_{pred} would match with the closest point in D_{gt}. If the extra points have no match in D_{gt}, these points would be compared with diagonal. Therefore, for D_{pred} of the prediction Y_{pred} and D_{gt} of the manually annotated ground truth Y_{gt}, the topology-constraint loss is formulated as:

$${L}_{t} = {\sum }_{k}^{p} {W}_{p} ( {D}_{pred}^{( k )} , {D}_{gt}^{( k )} ) .$$

Geometrical loss term L_{g} penalizes globally voxel-wise mismatches between TUNETr's predictions and the GT and topological term Lₜ encourages the predicted probability map to generate the similar amounts and structures of topology persistent homology with the GT.

Semi-Supervised Learning with Edge-Enhancing Pseudo-GT

In one embodiment of the present invention, there is provided a semi-supervised learning in addition to a large number of unannotated images in TUNETr. The iTUNETr is trained from a few manual GT with nuclei prior knowledge and iTUNETr synthesizes manually-annotated level pseudo GT from the massive remaining 3D images. From the multi-cell segmentation from iTUNETr, the clear binary cell membrane of time-lapse volumes is constructed with a shape-constraint module to select human-annotated level GT for sTUNETr (synthetically semi-supervised learning model, a part of TUNETr).

The module of an embodiment of the present invention is adapted to filter the volumes whose predicted probability maps are far away from their real topological structures and triple the fluorescence signal intensity in the outermost membrane of the GT to combat serious signal weakening problems.

With TUNETr boosts the potential and performance of the present model with only 71 labelled images. Even at the late-stage imaging domain, TUNETr provides human-level membrane recognition and cellular segmentation.

### Nucleus-Prompting for Multi-Cell Segmentation

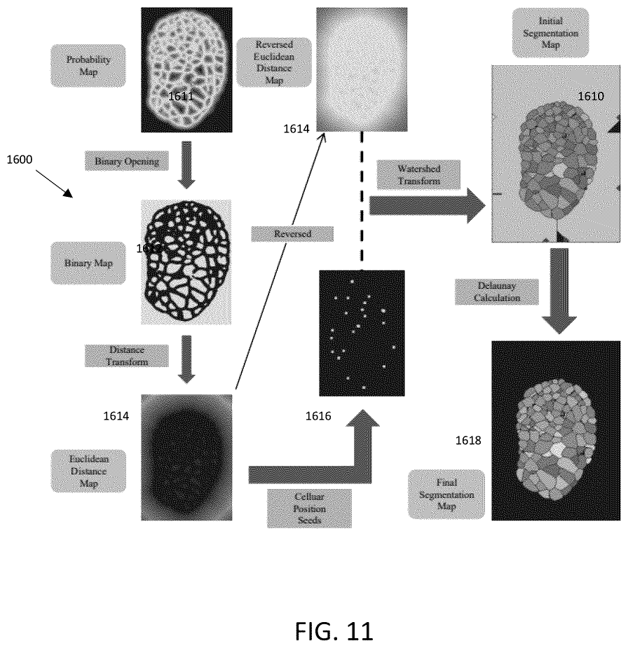

To mitigate multicell object segmentation from the occasionally incorrect recognition of cell membrane signals, TUNETr of an embodiment of the present invention utilizes the 4D multi-nuclei segmentation from StarDist3D and Delaunay-watershed algorithm in 4D membrane recognition (semantic segmentation) to generate robust and accurate multiple whole-cell regions (multi-cell segmentation) from an initial segmentation map 1610 as shown in FIG. 11. FIG. 11 shows a schematic diagram of 3D images processing dataflow of running output from Transformer network of TUNETr, Delaunay-Watershed graphical algorithm 1600. The dataflow is illustrated with 2D cut of the volumes. Cell membrane recognition (probability map prediction 1611), binarized membrane segmentation 1612, Euclidean distance transformed map 1614, cellular position seeding map 1616, multiple whole-cell segmentation 1618.

### Generating Multi-Nucleus Segmentation GT and Training the Model

In one embodiment of the present invention, embryonic nuclei tracing data is meticulously extracted from high-resolution 4D Fluorescence Imaging, as delineated in Section ‘4D Fluorescence Images and Cell Identities Acquisition’. This process entailed the precise determination of nuclear centroids, identities, and volumetric parameters. For the annotation of the nuclei ground truth (GT) dataset, encompassing 1270 in vivo embryonic volumes, we employed a multi-nucleus segmentation protocol. Each nucleus was annotated in three-dimensional space using spherical representations, meticulously ensuring consistency in resolution (H×W×D) with the corresponding cell membrane images.

Confronting the challenge of nuclear overlap, particularly pronounced in datasets beyond the 150-time point, the present invention innovatively adapted a new methodology. This adaptation involved halving the radii of the nuclear spheres, a strategic modification that significantly enhanced the spatial resolution of individual nuclei within densely populated regions.

Further, for the processing of nuclei GT, the star-convex polygon model is adopted, as conceptualized in StarDist, extending it to encompass 96 radial vectors. This approach facilitated the generation of a nuanced gradient map, capturing topological variances and the radial distances from each voxel to the nearest nuclear centroid. Integrating the advanced StarDist3D framework into our TUNETr system was pivotal. This integration was tailored for the nucleus-prompting mechanism, utilizing star-convex polygons with 96 radial vectors to render a topologically informed gradient map. This map was pivotal in conveying spatial relationships, delineating equidistant angular separations, and quantifying voxel-centric nuclear proximities.

For the optimal training of the star-convex polygon model, one embodiment of the present invention employed a hybrid loss function, synergistically combining Mean Absolute Error (MAE) and Binary Cross-Entropy (BCE). This dual-functional loss function was instrumental in refining voxel classification and probability prediction. To augment the fidelity of our model's output, one embodiment of the present invention implemented an advanced Non-Maximum Suppression (NMS) algorithm. This algorithm was critical in curtailing redundancy within the predicted volumetric data, thereby ensuring the integrity and precision of the segmentation outcomes.

Running Dual-Approach Strategy with Nucleus-Prompting

Using independent locations seeds unlike previous work, one embodiment of the present invention utilized the Delaunay clean method from them, where pixel clusters are organized into graphs using Delaunay triangulation. Without binarizing the grayscale probability maps and finding explicit nuclei position as local minima, which is suffering from implicit membrane recognition results, this step of TUNETr groups points near cell margins and assigns weights to graph edges. Overlapping cells (crossed edges and vertices) are also filtered out to achieve a cleaner segmented map. Conclude with marker-watershed segmentation using the refined seeds.

TUNETr capitalizes on the advanced capabilities of the marker-seeded watershed algorithm, to integrate experimentally determined multi-nucleus segmentation, into its computational framework. This integration is manifested in the refinement of the predicted probability map, hereafter referred to as Y_{pred}. The incorporation of multi-nucleus segmentation serves a dual purpose: firstly, it provides precise, automated localization and quantification of cellular dimensions, and secondly, it acts as a critical navigational aid for the segmentation of multiple cellular objects within complex morphological structures. The module's nuanced handling of spatial information and its sensitivity to cellular boundaries ensure that the integrity of cellular morphology is meticulously preserved, thereby enhancing the overall accuracy and reliability of the segmentation process.

### Implementation Details and Evaluation Experimental Setup

In one embodiment of the present invention, TUNETr is partly implemented with PyTorch, StarDist3D, SwinUNETR and MONAI modules available online.

It is trained on a computation station as shown in FIG. 1 with 2 NVIDIA RTX A6000 GPUs (48 GiB), 2 Intel Xeon Gold 6248R CPUs (3.00 GHz), and 1 TB physical memory. GPU driver version is 470.199.02 and CUDA version is 11.4. Python is 3.9.16, with 1.10.1+cu111 torch, 0.10.1+cu111 torchvision and 1.2.0rc7+22.g575954cb MONAI. The 3D iTUNETr, sTUNETr, and the StarDist3D model (all the trained DNNs model) in the end-to-end method TUNETr (the segmentation method of the present invention), as well as other comparing SOTA DNN models, are trained with the same computational resource and augmentation operation. The membrane recognition models are trained with 5000 epochs, 160×160×160 randomly cut volumes inputs. By perturbing the pixels' intensity (uniform distribution, scaled with the half-open interval [1,1.1) and shifted with [0,0.1)) and randomly flipping (50% chance to be flipped along the x, y, and z axes, respectively), the 71 3D manually annotated volumes in the training dataset were augmented to multiple different and effective training 160×160×160 cube images. The Adam optimizer is conducted to update the network with an initial learning rate of 5×10⁻³ and a weight decay rate of 1×10⁻⁵, using AMSGrad gradient descent optimization.

The evaluation experiments are conducted on 16 manually annotated volumes. The cell morphology of five embryos “WT_C_Sample2”, “WT_C_Sample3”, “WT_C_Sample4”, “WT_Sample1”, and “WT_Sample7” was annotated by ten well-trained experts based on the segmentation results from CShaper⁶, CMap³ and the raw fluorescence images. The segmentation results were manually checked and corrected slice by slice (2D view) and cell by cell (3D view), ensuring the correctness of the evaluation GT. Specifically, we gained time lapse and cell-number-wise GT data. First, the middle slice at each imaging time point throughout embryogenesis (255 2D images for “WT_Sample1” and 205 for “WT_Sample7”) was annotated for 2D comparison, providing the cross-section of 30509 cell regions in total. Second, the complete typical 3D volume within 100±5-, 200±5-, 300±5-, 400±5-, 500±5-, and 550±5-cell stages (2 late-stage 3D images for either “WT_Sample1” or “WT_Sample7”, 3 early stages for “WT_C_Sample2”, “WT_C_Sample3”, or “WT_C_Sample4”) were annotated for 3D comparison, providing the full morphology of 4046 cell regions in total.

### The GAN and Generative Transformer for Fluorescent Pseudo-Nucleus Images (Writing)

Another improved embodiment of the present invention uses the membrane segmented results from CTransformer and StarDist to feed the 3D cycle Generative adversarial network (3D-cycle-GAN) for generating time-lapse pseudo-nucleus fluorescence images. In this way, only membrane-labelled 4D images are required for building the cell-resolved morphology map for living organisms.

### Comparison on Cellular Segmentation

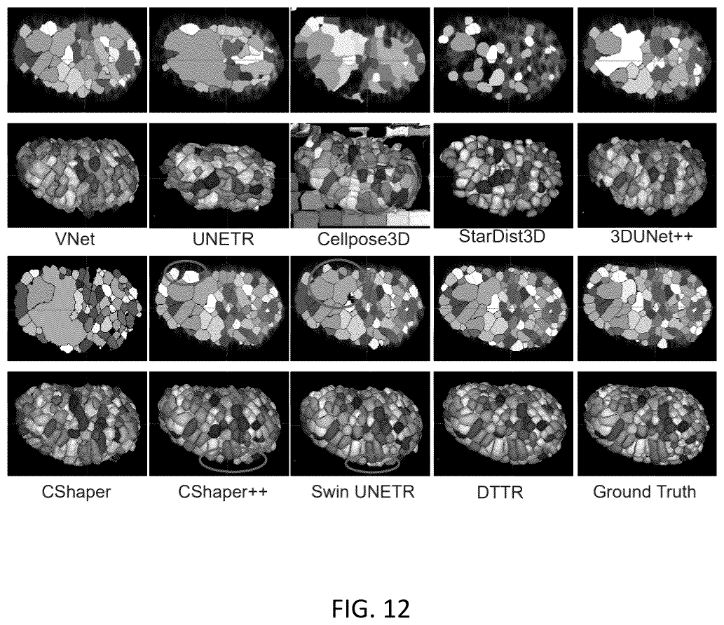

The CTransformer of an embodiment of the present invention was applied to delineate live-cell imagery of C. elegans, showcasing its superior ability in segmenting dynamic cellular structures. Qualitative and quantitative analyses were conducted, leveraging three pivotal metrics: Dice Score, Hausdorff Distance, and Jaccard Index. These metrics were chosen for their capacity to thoroughly evaluate segmentation performance across temporal sequences and varying cell stages, reflecting the intricate nature of embryonic development as shown in FIG. 12 to FIG. 15.

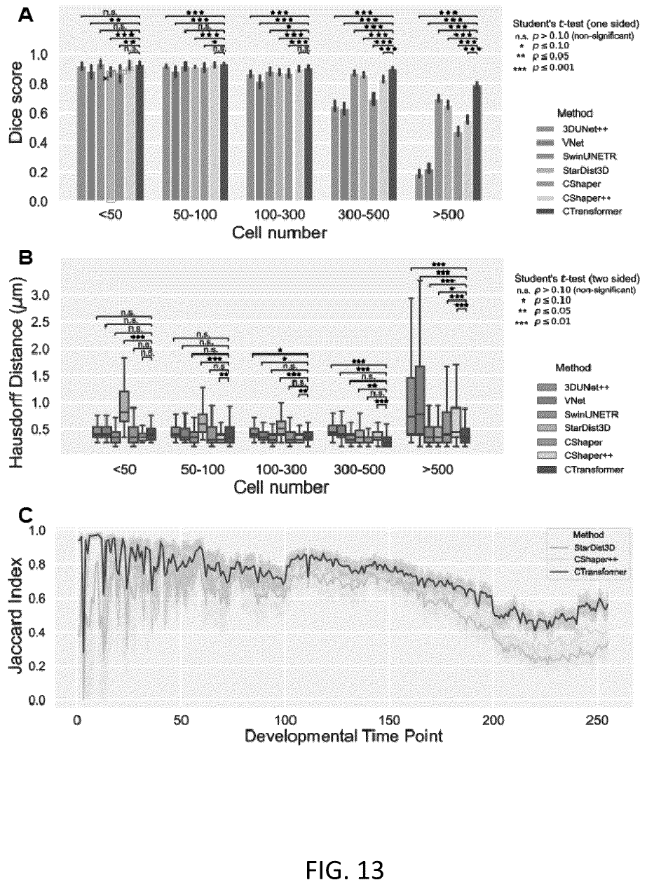

The 3D evaluation utilized manually annotated ground truths within 16 distinct 3D volumetric images, encompassing 2339 cell objects. This dataset was meticulously curated to ensure representation of significant developmental milestones, allowing for an in-depth assessment of segmentation capabilities prior to the 300-cell stage. Notably, it was observed a marked performance better than other DNN-based methodologies, demonstrating the consistent accuracy of CTransformer (FIG. 13, a and b, Supplementary 300-500 cell stage embryo showing).

FIG. 13 shows a schematic diagram of the quantitative evaluation of segmentation methods including: (A) Dice Score Comparison displays pixel-wise accuracy of six cellular segmentation methods compared with CTransformer, with the x-axis categorizing data by cell count within volumetric images; (B) Hausdorff Distance Analysis illustrates the performance disparities among different segmentation approaches across various typical cell stages, by significant margin, focusing on cell shape and boundary precision; and (C) Time-lapse Segmentation Performance examines the effectiveness of three segmentation methods over time, highlighting CTransformer's increasing superiority in later developmental stages of embryos.

To establish a benchmark, CTransformer was compared against other segmentation methods such as SOTA cell segmentation methods, including 3DUNet++, VNet, SwinUNETR, Cellpose3D, StarDist3D, CShaper, and improved CShaper, CShaper++. Each model was evaluated under identical conditions, ensuring a fair and unbiased comparison. The findings reveal that CTransformer greatly outperforms its counterparts across all developmental stages, under different imaging conditions, and irrespective of cellular layer depth.

Dice score is a statistic and pixel-wise measurement used to gauge the similarity between the predicted, Cell_{pred} cells, and the ground truth, Cell_{gt}, cells. It is defined as twice the area of overlap between the two segmentations divided by the total number of voxels in Cell_{pred} and Cell_{gt}, expressed as

$$Dice = \frac{2 \times \vert {Cell}_{pred} {∩Cell}_{gt} \vert}{\vert {Cell}_{pred} \vert + \vert {Cell}_{gt} \vert} .$$

A higher Dice score signifies a more accurate segmented cell. In particular, CTransformer achieved a Dice score of 0.908±0.003, demonstrating unparalleled accuracy in embryonic cell segmentation. This metric, indicative of the overlap between predicted and actual cell segmentations, underscores CTransformer's efficacy in capturing cell morphology, in the embryonic segmentation at different developmental periods (FIG. 13a). While the second best SwinUNETR got 0.888±0.006. CTransformer gets a better average cellular segmentation and also effective results after 300-cell stage images.

Additionally, the model's superiority was evident in its Hausdorff Distance score of 2.591±0.187 μm, signifying minimal boundary discrepancies and thus, a higher fidelity in cell shape representation. The Hausdorff distance is calculated by H(Cell_{pred}, Cell_{gt})=max(h(Cell_{pred}, Cell_{gt}), h(Cell_{gt}, Cell_{pred})), where

$$h ( {Cell}_{pred} , {Cell}_{gt} ) = {max}_{a ∈ {Cell}_{pred}} {min}_{b ∈ Ce l {l}_{g t}} \vert a - b \vert and h ( {Cell}_{gt} , {Cell}_{pred} ) = {max}_{b ∈ {Cell}_{g t}} {min}_{a ∈ {Cell}_{pred}} \vert b - a \vert ,$$

measuring the greatest of all the distances from a voxel in surface Cell_{pred} to the closest voxel in the other surface Cell_{gt} (FIG. 13b). CTransformer gets 2.591±0.187 μm (Table S2), significantly outperforming other methods by a significant margin, including SwinUNETR's 2.598±0.339 μm.

Moreover, the evaluation is extended to include time-lapse analyses of embryonic development, overcoming the challenges associated with constructing a comprehensive 3D+time ground truth. By annotating central 2D YZ plane cuts from over 200 volumetric series, there is provided a robust way for assessing segmentation performance over time. CTransformer demonstrated its time-wise robustness, maintaining higher accuracy levels as evidenced by its Jaccard Index score, which notably surpassed those of established methods like StarDist3D and CShaper++.

The Jaccard Index (JI, also known as IoU), is calculated on successfully segmented cells and then gets the overall cell-wise average score. Starting from 0 (the last 4-cell) to 255 (about 350 minutes, 589-cell) time point, all SOTA methods suffer from a decreasing JI over time. The degradation of the proposed method is numerically the smallest and the highest accuracy, which can be maintained at different stages of development. The higher JI, the better cell object segmentation. Evaluating the segmented volumes for the complete embryogenesis, CTransformer obtained a score of 0.715±0.02 (Table S3), which outperforms StarDist3D's 0.563±0.033 and CShaper++'s 0.673±0.037.

In summary, the statistical evaluation solidifies the CTransformer's status as an effective tool in the field of live-cell segmentation. Its proficiency across diverse metrics and conditions heralds a significant advancement in the accurate portrayal and understanding of cellular dynamics. Our findings not only validate the CTransformer's application in biological research but also open avenues for future explorations into its potential enhancements and broader implications in the realm of 3D biological imaging.

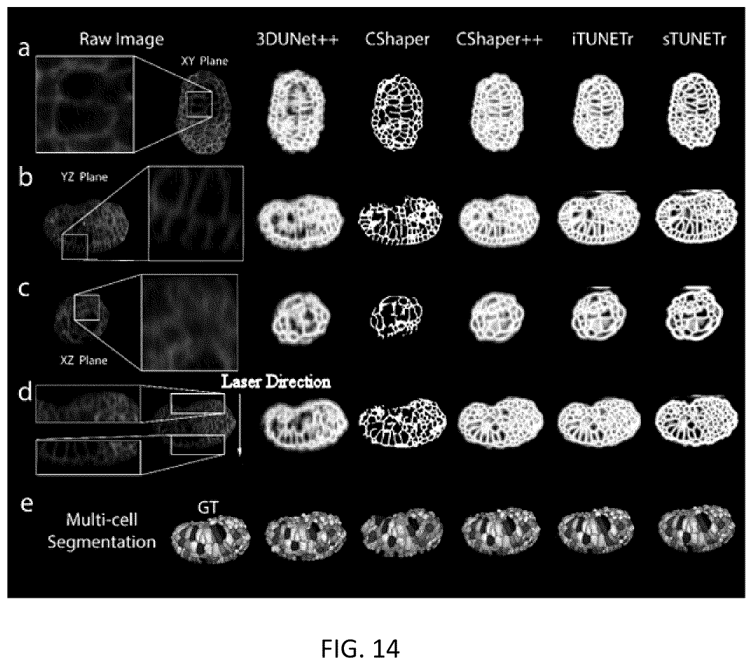

Globally, when fluorescence imaging and optical scanning 3D embryos are conducted, it is observed some intrinsic light heterogeneity and unbalanced weak signals. The fluorescence heterogeneity is shown in the first column of (FIGS. 14a and b). The brightness of cell membrane signals in the inner and middle layers are very different because the inner cells are larger and therefore their signaling proteins (mCherry) expressions are less densely dispersed. This intrinsic anisotropy would reduce a big inner cellular segmentation failure and severe cell loss.

The topological loss function is adopted in an embodiment of the present invention, cooperating with the large-scale model and suitable training strategies to ameliorate brightness imbalances by producing membrane recognition with consistent recognized results (the iTUNETr column of FIG. 14). Compared with other methods, the membrane recognitions have much lower anisotropic brightness distribution, no matter from which direction. The signal strengths recognized by the inner, middle, and outer cell membranes of the embryo are relatively balanced.

Similarly, low intensity and contrast signals also exist in the outermost layer of the cell membrane. This is due to two reasons. The first is because the inner cell membranes are in contact with each other, and there are two cell membranes with fluorescent protein expression; whereas the outermost cell membrane is in contact with the outside environment, which is only one layer of cell membrane, and the protein expression is only half of that on the inside, nearly disappeared (1^{st} column of FIG. 14b). This makes it very confusing for the DNN model to know if there are membranes. The second reason is that when the optical equipment scans the image layer by layer axially, there is a serious light scattering problem in the back half of the scan (1^{st} column of FIG. 14b). This is also a problem that image restoration and super resolution in post-processing are trying to solve, but they are still not conquered (for general images). TUNETr is effective in solving this weak edge signals problem that the outermost cell membrane is difficult to recognize. The CTransformer of an embodiment of the present invention can pay higher attention to thicken the membrane contacting with the environment, as shown in the 6^{th} column of (FIG. 14). Also with the above-mentioned topological loss, TUNETr connects the invisible membrane as well, by learning the cell membrane skeleton of the whole embryo in the topological latent space, which is relatively intact, rather than fragmented as in other models.

The CTransformer of an embodiment of the present invention has demonstrated that transformer based DNN and topological loss can ameliorate global imbalanced fluorescence intensity on the whole volume spatially. It is also shown that the TUNETr of an embodiment of the present invention is able to generate invisible membrane and axially undersampling signals. For living embryos, laser beam is always tuned down for ordinarily embryonic development, which would cause weak and ambiguous signals somewhere. The deficiencies in these images can be particularly severe in some areas (FIGS. 14c and d, >550-cell stage volumes), making the recognition of cell membrane significantly challenging. Inner and outer laser attenuation, top and bottom weak signals, and axial scattering are the main bafflements in identifying membrane signals. Meanwhile, restricted by the 3D scanning confocal imaging (2D slice by slice), axial direction (perpendicular to the shooting plane) has only low resolution (FIG. 14c). It is difficult to maintain spatial consistency of a living embryonic volume. Additionally, the areas circled by the large white rectangular box are the areas where the cell signal is severely blurred or disappeared, mainly in the last few layers of the slice for pseudo-3D imaging (FIG. 14d).

In one embodiment of the present invention. semi-supervised and edge-enhancing learning are introduced for the cellular segmentation of 4D live-cell embryos. The membrane recognition of CTransformer (sTUNETr column in FIG. 14), presents its comprehensive 3D membrane recognition for laser attenuated embryonic volumes. Qualitatively, these two new techniques allow the extract foreground (membrane) explicitly, without uncertain prediction around the membrane skeleton. For the axially (z direction) low-resolution issue (FIG. 3c), semi-supervised learning produced a lot of pseudo-GT data with topological priors (Materials and Methods), to provide detailed 3D cellular morphological information in every direction, including z. With a few annotated images and sufficient pseudo training data, sTUNETr reconstructed the cell membrane axially, in ambiguous images. At late-cell stage volumes, cells become extremely small, containing only less than 10 voxels or 3 axial pixels, in some cases. Thus, sTUNETr improving axially undersampling signals significantly enhances the constructions of not only ordinary cells but also irregular cell shapes, which are everywhere in large numbers in late-stage embryos. For laser attenuated areas, they can be successfully recognized and segmented (FIGS. 14d and c), with edge-enhancing training dataset (Materials and Methods). CTransformer has greatly improved the clarity and completeness of the membrane recognition of ambiguous signals, even though it is still not possible to recognize completely invisible signals perfectly. The clear membrane recognition makes the segmentation of the outer skin cells possible, whose positions exactly locate at the laser attenuated and invisible areas.

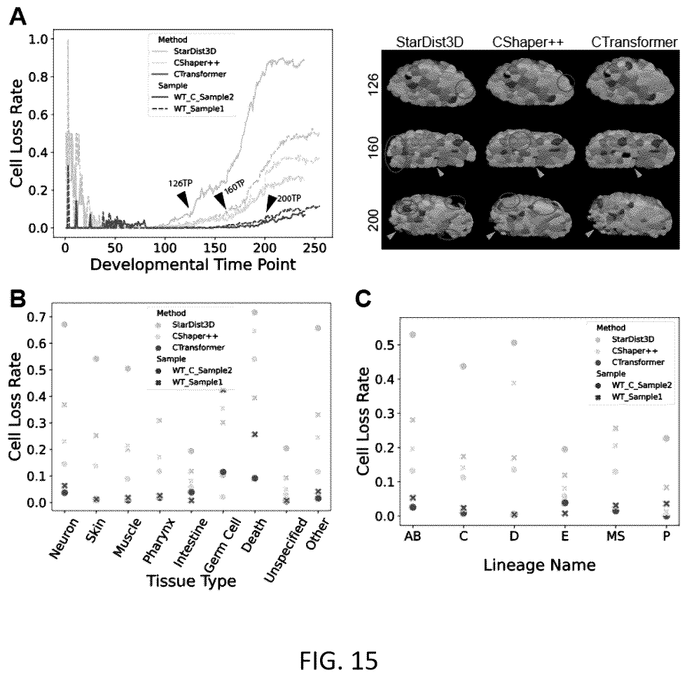

During embryogenesis, cells can undergo significant morphological changes, such as elongating and aligning in grid patterns to envelop the embryo. These transformations, particularly from spherical to elongated shapes, pose considerable challenges for standard DNN and instance segmentation algorithms. To address this, a dual-approach strategy combining automated processes with human-in-the-loop, known as the nucleus-prompting module is preferably introduced. This allows the CTransformer to reconstruct accurate morphology maps with minimal cell loss (FIG. 15a), effectively handling irregular shapes and nearly invisible regions by concurrently segmenting nucleus and membrane images.

TUNETr's performance surpasses that of other methods (FIGS. 13 and 14), maintaining robust, accurate 4D cell segmentation across time, tissue types, and lineages (FIG. 15). The evaluation is conducted on two wild-type C. elegans embryos (FIG. 15). Cell loss rate is determined by comparing against manually traced nucleus number to assess the proportion of missing cells in predictions. CTransformer successfully generated 96.5% of cell objects, while StarDist3D and CShaper++constructed 62.0% and 83.7% cells in the two representative evaluating embryos. Considering both the cell shape accuracies and recognized cell rates, CTransformer's segmented cells exhibit high time-wise consistency with the real embryonic cell atlas than other cellular segmentation methods. For highly elongated cell shapes, with the aid of the nucleus-prompting and dual-approach strategy modules, the proposed method adeptly segments them, specifically skin cells, with remarkably low loss rates (around 1%), achieving a tenfold improvement over competing method (FIG. 4b). Furthermore, by employing our method, we've managed to reduce the average loss rate of cells in extremely small size (less than 10 μm\hat{ }3), like apoptotic cells, to approximately 20%. This significant improvement enables more feasible studies of apoptosis engulfment, supported by the detailed cell-cell contact atlas produced through our segmentation process.

This breakthrough enables the generation of previously inaccessible morphological data for skin and apoptotic cells within living embryos.

Skin cells are a group of important issues moving outer and covering other inner cells from 350-cell stage. After 500-cell stage, the skin cells have encapsulated more than 60% of the embryo's surface and are growing and closing in over time. Over time, skin cells would deform incredibly long and cover muscle and intestinal cells from the left side around the back to the right side. Because the latest stage volume in the training GT is 400-cell stage and TUNETr has already push the error-free skin cell segmentation 190-cell stage later without additional information. Thus, TUNETr can reconstruct the error-free skin cells before 590-cell stage but still encounter increasing errors after that (FIG. 4a).

By utilizing a limited number of 3D ground truth volumes, the CTransformer of an embodiment of the present invention can now more reliably analyze cell shape deformations and clustering patterns across different species, paving the way for new insights into cellular and developmental biology.

Under different imaging conditions, for the ambiguous situation and late developmental time point, the images suffered from unavoidable laser attenuation and cells have grown in deformed shape, which is far from the images and shape in the training data. The cell shape generation and reconstruction capability for two most challenging cell fates are presented in FIGS. 15a and b. Even with fuzzy input 3D volumes or unsuitable cell membrane recognition methods, this module keeps the results from degrading too quickly. During a long-range developmental period, from 4- to 550-cell embryogenesis, TUNETr shows the ability to segment difficult cell morphology with good robustness, which also validates the generalizability of our method.

FIG. 15 shows time-lapse analysis of cellular segmentation performance of the Ctransformer of an embodiment of the present invention. FIG. 15A shows Embryonic cell loss rates, demonstrate the rate at which cells are lost in two sample embryos throughout embryogenesis. It includes half-cut segmented 3D images that reveal changes in cellular morphology at three pivotal developmental junctures. FIG. 15B shows Tissue-specific cell loss rates, displays the variation in cell loss rates among different tissues or cell fates throughout the entire embryogenesis of two embryos. FIG. 15C shows Lineage-specific cell loss rates, details the cell loss rates within specific lineages across the development of two embryos, providing insights into segmentation consistency across generations.

### Delicate

In one embodiment of the present invention provides a new method, Deep Learning Cell Enhancing Technology (DELICATE), for enhancing automated cell lineage tracing of time-lapse 3D fluorescence imaging, for C. elegans. DELICATE enhanced the low Signal-to-noise ratio (SNR) and imbalanced brightness nuclei fluorescence images. The method reduces the recognition errors of StarryNite and the time required for manually correcting automated generated lineage tracing from one week to one day, allowing fast-generated and accurate large-scale nuclei lineage tracing dataset.

As a light-weight deep learning network and data-driven model, DELICATE is customized for C. elegans with small labelled dataset, only 6 training embryos, providing a fast and accurate cell lineage tracing enhancement to 550-cell stage. The method of the present invention enhanced the 2D images via 3D segmentor-DNN, which improves the SNR, fluorescent signal strength, and effective information content of the images.

Comprehensive evaluation has been conducted from both image processing and biological application, and the results show that enhanced images have greatly improved in both respects; it also shows that the method works on images under different worm maintenance and microscopic imaging conditions. Practically, the present invention provides a user-friendly and cross operation system interface for biologists to establish the cell lineage tree to 550-cell stage within a day. The method of an embodiment of the present invention improves the feasibility of establishing a large-scale cell morphology database that requires accurate cell-resolved lineage tracing.

### Image Acquisition Step for DELICATE

All embryos in this study are wild-type. The SP 5 confocal microscope with tile scanning and merged using LAS X software (Leica) were used for imaging at a steady temperature of 20° C. GFP and mCherry fluorescence were recorded with a frame size of 712×512 pixels (x/y resolution: 0.09 μm) and a scanning speed of 8000 Hz using a water immersion lens. Excitation lasers of 488 nm for GFP and 594 nm for mCherry were employed. A total of 92 focal planes were sequentially captured for four embryos per session, with a z resolution of 0.42 μm and at intervals of approximately 1.5 minutes (table S3). Imaging was conducted continuously over at least 240 time points. The imaging session was segmented into five phases to handle changes in fluorescence signal during development: 1-60, 61-130, 131-160, 161-200, and 201-240 time points. Z-axis compensation was set at 0.5-3% for the 488 nm laser and 20-95% for the 594 nm laser. The pinhole sizes for these phases were 2.3, 2.0, 1.6, 1.6, and 1.3 Airy Units, respectively.

To ensure that the embryo is not compressed, the image acquisition preprocessing is divided into two parts. First, preparation of the substrate. a solution of polylysine and Boyd's buffer was mixed in equal parts. Approximately 7 μl of this mixture was carefully pipetted onto a glass slide, where it was spread to form a rectangular pad measuring roughly 0.7 cm by 1 cm. This slide was then placed on a heating block set at 60° C. to dry the solution. Following the drying process, small dots of Vaseline were applied just outside each corner of the polylysine-Boyd's buffer pad to serve as supports for a cover slip.

For the embryo dissection and mounting, standard protocols for dissecting embryos were followed until it was time to transfer them onto the prepared slide. At this stage, a tiny drop of Boyd's buffer was placed onto the prepared pad, where it was observed to spread within the confined area. Embryos were then transferred individually using a capillary needle, ensuring that any excess buffer was expelled from the needle tip prior to transfer. As embryos were blown out onto the pad, a brief pause of 3-5 seconds was allowed for each embryo to settle before introducing the next. Once all embryos were positioned on the pad, they were left to settle for an additional 20-30 seconds before being covered with 12-15 μl of Boyd's buffer. A cover slip was then gently laid over the embryos, resting on the Vaseline dots to avoid direct contact with the buffer. The cover slip was then methodically pressed at each corner until it contacted the buffer, ensuring that the embryos remained within the intended area. To finalize the preparation, the edges of the cover slip were sealed with molten Vaseline, creating an airtight environment to maintain the sample's integrity for imaging.

For confocal imaging, the GFP and mCherry channel were used to collect cell nuclei and membrane signal with 0.01%-0.75% and 0.35%-7.7% laser separately. This laser setting was utilized to capture images at five distinct positions of the embryos, with each position undergoing 92 focal steps per time point (˜90 seconds/tp). Five different blocks with different pinhole and gain were set according to the fluorescence intensity. Block1 (60 tp): pinhole: 2.7, gain for GFP: 110, gain for mCherry: 160; Block2 (30 tp): pinhole: 2.4, gain for GFP: 80, gain for mCherry: 100; Block3 (40 tp): pinhole: 2.1, gain for GFP: 70, gain for mCherry: 60; Block4 (30 tp): pinhole: 1.8, gain for GFP: 70, gain for mCherry: 25; Block5 (90 tp): pinhole: 1.6, gain for GFP: 40, gain for mCherry: 20. Following the collection of images, we use Huygens for image deconvolution and the following output will be used for image enhancement.

### Cell Lineage Tracing Step and Manual Annotated Ground Truth

The automated cell lineage tracing step in one embodiment is generated by StarryNIte and manually corrected in Acetree. The lineaging errors were manually corrected up to the 550-cell stage, until C lineage finished all divisions.

The training labeled data, also known as the ground truth (GT), is generated from the corrected cell lineage tracing results. The researcher then facilitates, corrects and double-checks 6 typical live embryos' lineage nuclei tracing files, which contained the xyz positions and sizes for all cell nuclei at their lifecycle during embryogenesis from at least 4- to 550-cell stage. According to the accurate cell nuclei positions and the corresponding size (radius), spheres of the right size were used to represent cell nuclei and placed to the right locations for all cell nuclei in the 3D GT images. Collectively, there are 6 embryos with total 1,270 3D volumetric images (the embryogenesis by 550-cell stage) in the training dataset for the segmentor-DNN training, which is corresponding to 98,360 2D images. The training data concluded a big range of images under harsh or clear imaging conditions, which make the data-driven segmentor-DNN, as well as our enhancement method DELICATE, work well on the fluorescence images under various imaging conditions.

### Implementation of the DELICATE Method: DNN Structure, Bioimage Processing and Training

The method of an embodiment of the present invention and the corresponding software were implemented with TensorFlow, StarDist, and Pyqt5 which can be found online. The programs of an embodiment of the present invention are built with Python. In one embodiment, the software comprises built-in Res-Net of segmentor-DNN from TensorFlow and StarDist, which provide a stable segmentor-DNN. Additionally, there is also provided a user-friendly interface software for researchers to enhance the nuclei fluorescence images without programming. The software interface with complicated algorithms and processing steps are described one by one.

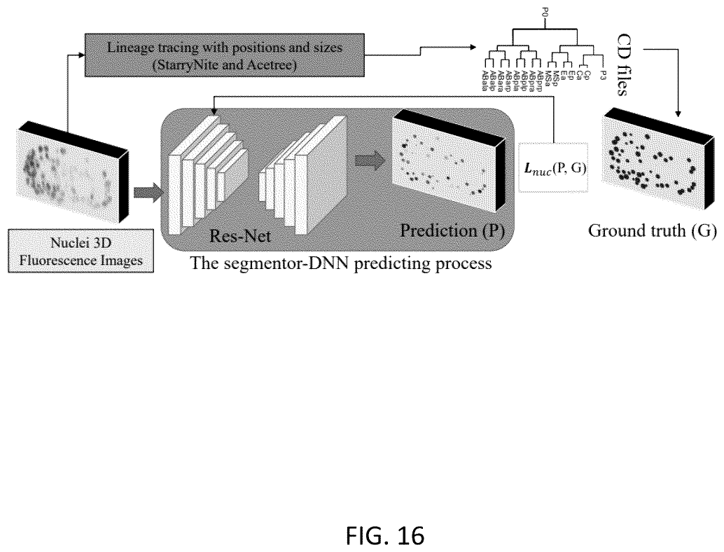

The segmentor-DNN used UNet architecture of depth 4, which can learn the significant spatial information in biomedical images. The integrated model contains multiple residual blocks of Res-Net that enable both fusion and communications between early (shallow) and late (deep) layers as shown in FIG. 16.

FIG. 16 is a schematic of the workflow of DELICATE in accordance with an embodiment of the present invention. The ground truth generation, training, and image enhancement running processes are demonstrated. The L_{nuc}(P, G) is the training target for the DNN network. Prediction is the results generated by the DNN by learning from the Ground truth.

The model takes the single 3D volumetric image input as a probability map of one cell object and the radial distance to the cell nucleus' boundary in star-convex polygon form. Consequently, the voxels with high probability (larger than an automatically generated threshold) are recognized as the cell nucleus' boundary, as a polygon with 64 rays. At last, a non-maximum suppression is applied for pruning redundant overlapped nuclei. Following this, multiple cell nuclei regions in the 3D image are uniquely segmented facilitating the following steps of fluorescence image enhancement and merging.

The inputs for the segmentor-DNN were GFP-labeled nuclei fluorescence images, with the corresponding ground truth (GT) images serving as the learning/fitting targets. During training, the input image (Iᵢₙₚᵤₜ) underwent random noise addition, was cropped to a volumetric size of (128×128×128), and flipped to augment the dataset, thereby enhancing the network's robustness. The Adam optimizer was employed with an initial learning rate of (5×10⁻³) and a weight decay rate of (1×10⁻⁵), complemented by AMSGrad for gradient descent optimization, to update the network. The model underwent training over 400 epochs with a batch size of 8, utilizing an NVIDIA 2080 Ti GPU. The loss function is defined as L_{nuc} (P, G)=L_{obj}+ηL_{dist} (Weigert et al. 2020). The segmentor-DNN automatically chooses the final parameters with the smallest validation loss during training to reduce the overfitting risks.

DELICATE aims to acquire superior accuracy of nuclei detection and cell lineage construction, while keeping the necessary fluorescence signals and most information of cell nuclei for biologists to observe and correct the time-lapse cell development. Thus, this method merges the segmented pseudo-nuclei I_{pseudo} (prediction in FIG. 16) into raw 2D fluorescence images I_{raw} to enhance the ambiguous and unseen areas with Φ(I_{raw}, I_{pseudo}) for every νᵢ in I_{raw}, that is defined as:

$$Φ ( {I}_{raw} , {I}_{p s e u d o} \vert {v}_{i} ) = \{ \begin{matrix}{v}_{i} in {I}_{r a w} , & {v}_{i} of {I}_{pseudo} is 0 \\ max ( {I}_{r a w} ) , & else\end{matrix}$$

The enhanced images concluded both fluorescence signals and pseudo-nuclei information. The input (from deconvolution software) and output (compatible with StarryNite) images are both TIF format 2D images, which strictly follow the previous criteria. The interface runs the enhancement for one embryo once, taking 0.5 hour to finish this fully automated process.

### Characterization of Errors Made by StarryNite

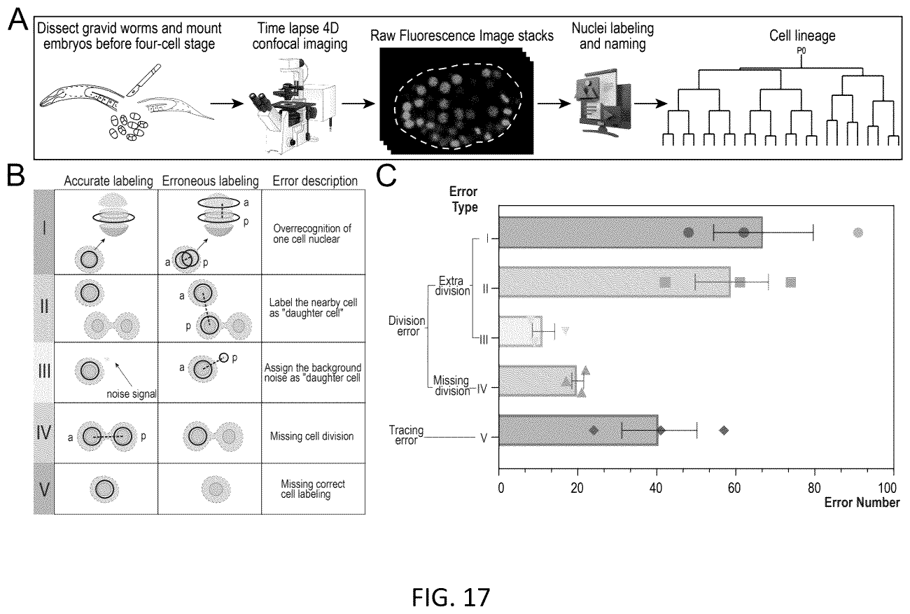

FIG. 17 shows the characterization of errors by StarryNite in C. elegans embryo. FIG. 17A shows a pipeline of live cell imaging and automated cell lineage analysis. The automated nucleus tracing and naming is achieved by StarryNite with fluorescence-labeled nuclei as an input. Manual curation is needed to correct the errors in nucleus segmentation or tracing in order to build an accurate cell lineaging tree. FIG. 17B shows nucleus labelling errors are categorized into five classes. Shown in FIG. 17 is the schematic representation of the comparisons between accurate and erroneous nucleus segmentation and tracing for each error class. Shown on the right is the description for each erroneous labeling. FIG. 17C shows occurrence of each error class. The bar plots depict the mean number of each error class observed between approximately 160-cell to 360-cell stage during embryogenesis for three independent embryos.

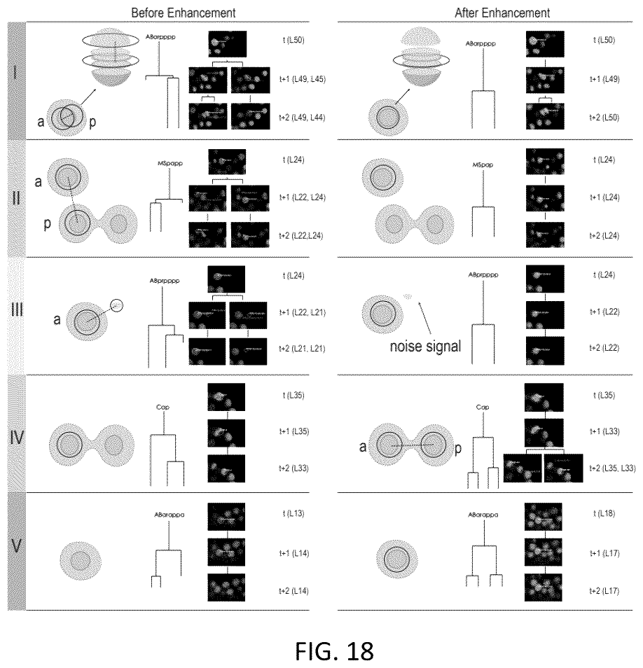

To systemically understand the errors made by StarryNite during lineage tracing (FIG. 17A), the errors were manually corrected in three independent embryos and grouped the errors into broad categories, i.e., division error and tracing error (FIG. 17B). To facilitate the classification of the errors especially at a late embryo in one embodiment, those between approximately 160-cell to 360-cell stage for three independent embryos are counted except stated otherwise. Most errors are division ones, whereas the tracing errors are produced by the false negative calling of a cell (FIG. 17C), usually due to a poor SNR of images. The division errors were grouped into four classes, three of which led to extra division, while the last class caused missing division. Among the errors leading to the extra division, those with the highest occurrence are produced by over segmentation of nuclei, frequently on the z axis, which is referred to as class I (FIG. 17B and FIG. 18). The second highest class of error, i.e., class II error, was mainly due to the movement of nuclei, leading to the proximity of two non-sister cells that were wrongly treated as a new sister pair, and calling of new division. The third class of error was caused by the false positive calling of a nucleus from background noise, which is the least observed errors out of all classes (FIG. 17B, FIG. 17C and FIG. 18). The class IV and V errors were caused by the false negative calling of a nucleus. The former results in a missing division whereas the latter leads to a false cell death, which is the third most common classes of errors (FIG. 17C). We did not characterize the “false diameter” type of error because such error barely influences the lineaging construction as long as the cell calling is accurate.

FIG. 18 shows the raw fluorescence images associated with errors shown in FIG. 17B. For each class of error, one typical sublineage is shown before (left) and after nuclei image enhancement (right). The cell nuclei are automatically recognized and named by StarryNite and AceTree.

### Pipeline and Evaluation of DELICATE

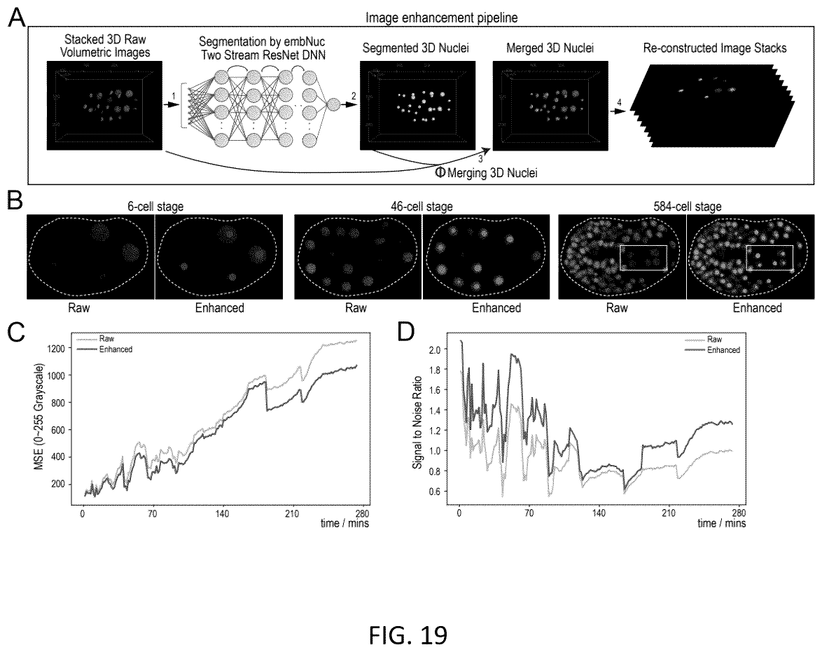

Reference is now made to FIG. 19. FIG. 19 shows an image enhancement workflow of DELICATE—Deep learning cell nuclei enhancing technology. FIG. 19A shows the pipeline of DELICATE. 2D fluorescent image stacks are first constructed as raw 3D volumetric blocks. The blocks are used as the input for a fast and light deep learning model, which is customized for time-lapse 3D cell nuclei images, to generate segmented 3D nuclei blocks. The raw and segmented 3D image blocks are subsequently merged, formulated and re-sectioned into 2D image stacks that are used as input for StarryNite. FIG. 19B shows the comparison of nuclei signal intensities between raw and enhanced images across different embryonic developmental stages. Eggshells are indicated with white dashed lines. Note that E lineage cells before and after image enhancement are highlighted in a white rectangular area. FIG. 19C shows comparison of Mean Square Error (MSE) between raw (cyan) and enhanced images (red) for one embryo across time. Shown is the Mean Square Error (MSE) value of individual time point from 0 to 280 mins. Note that a lower MSE depicts less signal discrepancies from ground truth images. FIG. 19D shows comparison of Noise Ratio (SNR) measurements of raw (cyan) and enhanced images (red) for the same embryo as in FIG. 19C that shows across time. Note that a higher SNR means more signals and less noises for nuclei tracing.

To systematically reduce the errors generated from StarryNite during lineage tracing, a preferred embodiment of the present invention provides an automated pipeline to improve the image quality for StarryNite, i.e. DELICATE. This is an integrated and customized pipeline for enhancing nuclei tracing and accelerating lineage establishment in vivo embryos. The models, algorithms, and corresponding software are built with pre-trained deep neural network (DNN) based image processing algorithm and fitted on raw fluorescence nuclei images of C. elegans. The dataflow and workflow are demonstrated (FIGS. 19A and 16).

Step 1, the 2D raw images are stacked and reconstructed to the 3D volumetric images according to imaging resolution, which is keeping the scaled real-world embryo shape. In this step, the 3D images are performed per-image intensity contrast refinement as well.

Step 2, the 3D images are processed by the segmentor-based DNN (deep neural network, designed for segmentation), and the network produces the detection results for every single nucleus object (region), with clear boundaries between each other (foreground and background). The detected/segmented nucleus is a connected sphere-like region, which is a pseudo-nucleus object created from the nucleus fluorescence signals.

Step 3, the artificially generated (segmented, pseudo-nuclei) 3D images are converted back (cut with corresponding z-axis intervals) to 2D images.

Step 4, DELICATE combined the raw 2D fluorescence images, I_{raw}, with the corresponding cut 2D pseudo-nuclei images, I_{pseudo}, from the pseudo-nuclei images with merging operation Φ(I_{raw}, I_{pseudo}), for the final enhanced 2D fluorescence images I_{enhanced}. With this combination, we keep the raw and real nuclei signals when the DNN fails to detected/segmented some nuclei regions (FIG. 19A). The enhanced 2D images maintain complete consistency with the originals, ensuring they are fixed and compatible for lineage tracing. User should run the proposed independent DNN enhancement for nuclei tracing before StarryNite.

For evaluating the enhanced images in a preferred embodiment of the present invention, both qualitative and quantitative were conducted for comparison. The brightness of the most blurred sublineages D, E and germline progenitors, P4, Z2 and Z3, has been significantly enhanced (FIGS. 19B and 18), especially during later stages when the cells are numerous and dense. Two metrics for image-wise comparisons were used, mean square error (MSE) and signal to noise ratio (SNR). MSE, based on pixels, and SNR, based on the whole image, are formulated respectively as:

$$\begin{matrix}MSE = \frac{1}{m n} {\sum }_{i = 1}^{m} {\sum }_{j = 1}^{n} {( {I}_{g t} ( i , j ) , I ( i , j ) )}^{2} \\ SNR = \frac{{P}_{signal}}{{P}_{n o i s e}}\end{matrix}$$

The P_{signal} and Pₙₒᵢₛₑ are the power of signals and noises in the images, the total intensity of the corresponding pixels. In this study, the signals are the voxels within the cell nuclei regions marked in the GT images, while the noise is outside the regions. Compared with the raw images I_{raw}, the enhanced images I_{enhanced} demonstrate greatly reduced pixel-wise MSE and increased image-wise SNR (FIGS. 19C and D), during the entire developmental embryo.

### DELICATE Significantly Reduces all Classes of Errors Made by StarryNite

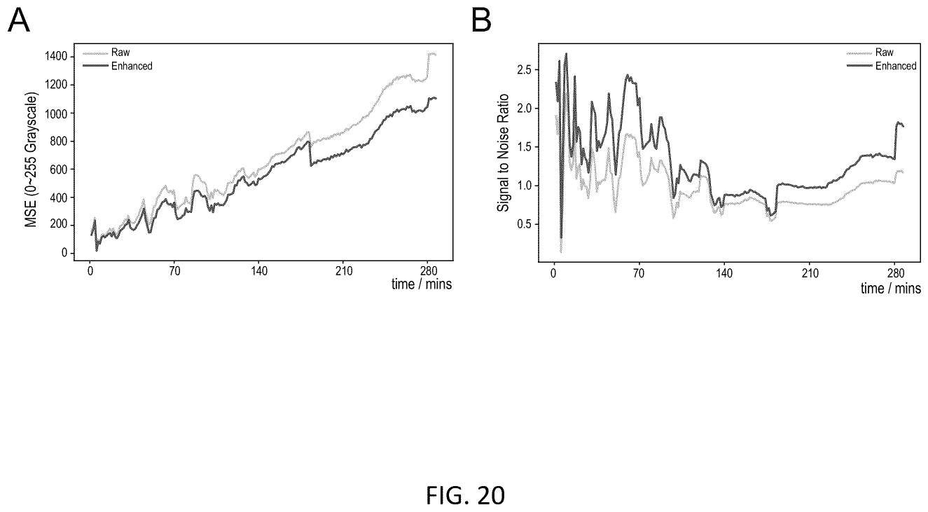

To further evaluate the effect of DELICATE on the reduction of errors made by StarryNite, the images of the same three embryos as those used for the error characterization with DELICATE were first processed. In the previous section, MSE was adapted for comparison, a commonly used index to depict signal discrepancy from the ground truth, of the fluorescence images over time before and after processing with DELICATE. It was observed a consistently smaller value in MSE over development relative to that before treatment with DELICATE, especially after approximately 170 minutes of imaging when the embryo develops from 350-cell stage to 550-cell stage, suggesting that DELICATE treatment would reduce errors mostly after 350-cell stage (FIGS. 19C and 20A). To further evaluate the benefit of DELICATE treatment on the cell lineage analysis, SNR of the fluorescence images were compared over time before and after processing with DELICATE. Again, it was observed a consistently higher SNR over development relative to that before treatment with DELICATE, especially after approximately 170 minutes of imaging, suggesting that DELICATE treatment would greatly reduce errors after 350-cell stage (FIGS. 19D and 20B).

FIG. 20 shows comparable enhancement of image quality for another independent embryo as those shown in FIGS. 19B and C. FIG. 20A shows comparison of Mean Square Error (MSE) between raw (cyan) and enhanced images (red) for the embryo across time. Shown is the Mean Square Error (MSE) value of individual time point from 0 to 280 minutes. FIG. 20B shows comparison of Noise Ratio (SNR) measurements of raw (cyan) and enhanced images (red) for the same embryo as in FIG. 20A across time.

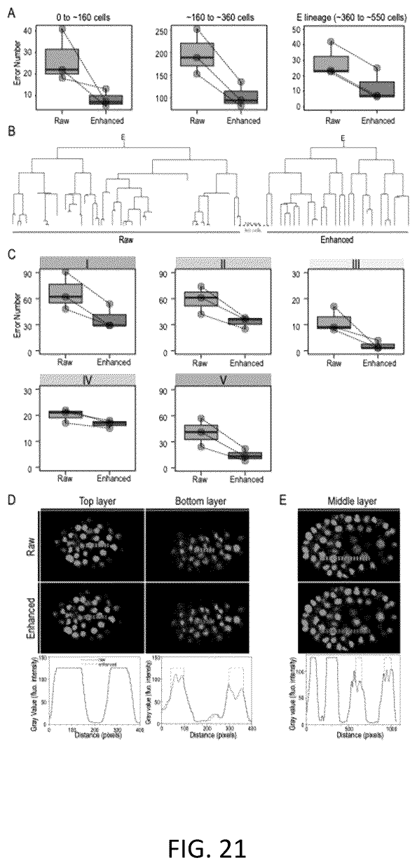

The total number of errors made by StarryNite were comprehensively counted and contracted from early (0 to 160-cell), mid (160 to 360-cell) and late embryogenesis (360-550 cell, E lineage only) in the three embryos before and after DELICATE treatment (FIG. 21A). It was observed a drastically reduced number of errors by nearly a half across all developmental stages, which is evident from the raw lineage tree output by StarryNite (FIG. 21B).

FIG. 21 shows a stark decrease in the occurrence of errors in nuclei segmentation and tracing after image enhancement.

FIG. 21A is a diagram showing quantification of errors before and after image enhancement across three consecutive embryogenesis intervals. The paired box plots show the mean number of total errors before (brown) and after image enhancement (green) for three embryonic stages: i.e., 0-˜160 (left), ˜160-˜360 (middle) and ˜360-˜550 cells (right). Shown are the data from three independent embryos. Error numbers for the same embryo before and after image enhancement are connected by dashed line. Note that only the error numbers from the E lineage are counted in the ˜360-˜550 cells stage for simplicity. FIG. 21B is a diagram showing comparison of E sub-lineage trees output by StarryNite without manual curation before (left) and after image enhancement (right). FIG. 21C is a diagram showing classes of errors are substantially reduced after image enhancement. The paired box plots show the mean number of errors before (brown) and after imaging enhancement (green) counted from ˜160 to ˜360-cell stages for three independent embryos. Error numbers for the same embryo before and after image enhancement are connected by dashed line. FIGS. 21D and E are diagrams showing reduced inconsistency in fluorescence intensity from images acquired from different focal planes. Shown are the representative fluorescent images and the measurements of their signal intensity for the images taken at the top and bottom layer (D) or middle layer (E). Fluorescence signal intensities before (blue) and after image enhancement (red) measured for the regions indicated with dashed lines are shown at the bottom. Note that without imaging enhancement, nuclei fluorescence is dimmer at the bottom layer compared with that at the top layer due to light scattering, whereas the fluorescence intensity of the E cell nuclei is dimmer even in the middle layer compared with neighboring nuclei from other sublineages due to the uneven expression of the histone markers.

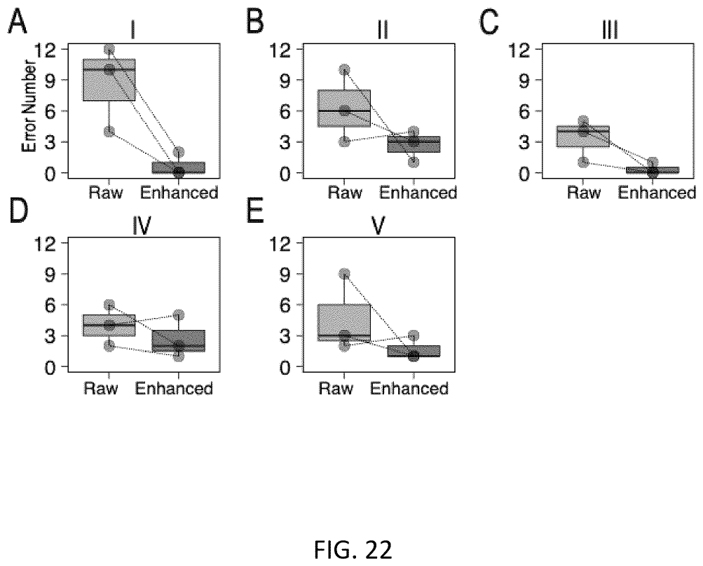

To deeper investigate where there is any bias in terms of error reduction between different classes of errors, the number for each class of errors in the three embryos was compared from 160 to 360-cell stage based on the fluorescence nuclei images. It was found most classes of errors show a reduction of approximately half of errors except for the class IV, which shows about 10% reduction in error number (FIGS. 21C and 22). To further understand how the images processed by DELICATE show a better performance in image segmentation, direct measurement of gray value across adjacent nuclei was performed. It was found that inherent fluorescent intensity variations can be perfectly resolved. For example, the dim signal at the bottom layer of the sample slide, caused by more severe light reflection during confocal microscopy, is increased comparable to those at the top layer with no change for background. (FIG. 21D). Similarly, the dim expression of the florescent marker in the E cells in the middle layer can be enhanced to achieve uniform intensity compared with neighboring cells (FIG. 21E). Taken together, we devised a framework, DELICATE, for the enhancement of nucleus fluorescence images in C. elegans embryo, which significantly reduces the number of various types of errors made by StarryNite. Therefore, it reduces the time for manual correction by at least a half to perform automated cell lineage analysis. The framework is expected to improve the segmentation performance of other types of images that demand a high SNR.

FIG. 22 is a diagram that shows classes of errors are substantially reduced after image enhancement as in FIG. 3B except that errors were counted from ˜4 to ˜160-cell stages. The paired box plots show the mean number of errors before (brown) and after imaging enhancement (green) for three independent embryos each. Error numbers for the same embryo before and after image enhancement are connected by dashed line.

### Comprehensive Tracing Error Improvement for DELICATE

To comprehensively evaluate the efficacy of the DELICATE enhancement pipeline, a comparative error analysis was conducted after automatic recognition by StarryNite between the raw dataset and enhanced dataset. Error incidences were counted for both the unprocessed and enhanced datasets, spanning from the initial time point up to the 160-cell stage. The error number decreased to nearly half after the enhancement pipeline.

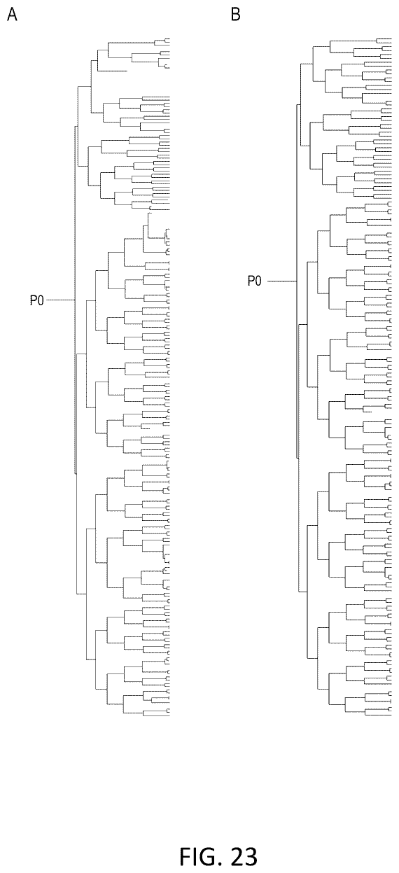

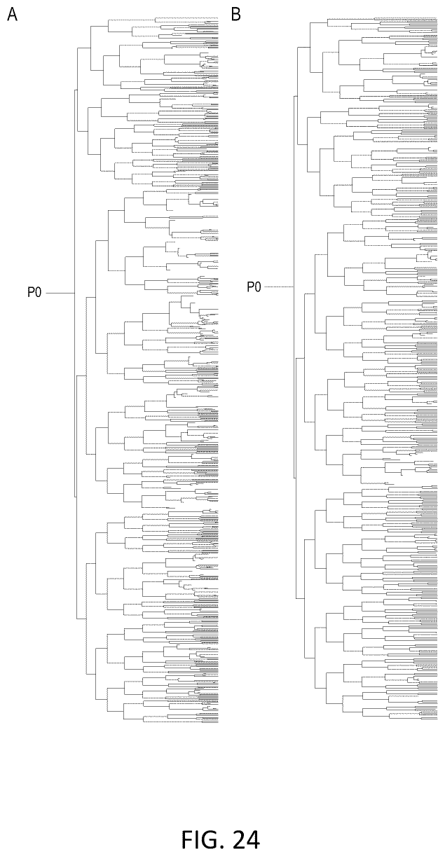

The analysis was then extended, and all detected errors before 160-cell stage were manually corrected to ensure accuracy in subsequent stages of analysis. The error frequencies were quantified from the 160-cell stage through to approximately 360-cell stage, and the enhancement pipeline also has an effect of reducing half of the errors. Recognizing the challenges associated with manual error rectification in the densely populated stages of 350 to 550 cells with the comparative results were depicted in FIG. 21A. In all, the DELICATE enhancement pipeline can greatly improve the error incidences. Additionally, the lineage trees produced by StarryNite were scrutinized, with the raw lineage representations (E lineage) presented in FIG. 21B. A detailed characterization of error types was performed to gauge the specific enhancements afforded by the DELICATE pipeline (FIGS. 23 and 24).

FIG. 23 is a diagram that shows comparison of lineage tree up to ˜160-cell stage from the same embryo output by StarryNite without manual curation before (FIG. 23A) and after image enhancement (FIG. 23B). FIG. 24 is a diagram that shows comparison of lineage tree from ˜160 to ˜360-cell stage of the same embryo output by StarryNite without manual curation before (FIG. 24A) and after image enhancement (FIG. 24B).

This investigation revealed a uniform reduction in the occurrence of all error types post-enhancement. Notably, the pipeline of a preferred embodiment excelled in mitigating the inherent fluorescence intensity variances that are typically accentuated between the upper and lower layers of cells during standard imaging processes. Post-processing, a remarkable homogenization of fluorescence intensity was observed, effectively equalizing the signal across these disparate layers, as evidenced in FIG. 21D. Equally impressive was the improvement in fluorescence intensity consistency within the same layer amongst different cells (FIG. 21E). These results collectively affirm the substantial impact of the DELICATE pipeline on enhancing the fidelity of image data, thereby significantly advancing the precision of automated cell lineage tracking.

Automated cell lineage tracing with time-lapse 3D fluorescence images of a live organism emerges as an essential tool for in-depth study of regulatory control of the developmental process with cellular resolution at one-minute intervals. Existing algorithms for nucleus segmentation and tracing often suffer from a higher error rate, which demands substantial human interventions to manually correct the errors before a decent cell lineage can be achieved. These errors are mainly due to the crowdedness of the labeled nuclei that are small and undergo rapid movement, which makes it difficult to accurately call a real division or cell movement. In addition, a relatively poor image quality imposed by a tradeoff between viability and photobleaching and/or phototoxicity also negatively impacts the accurate segmentation. On top of this, the uneven fluorescence intensity and the size of nuclei across cell types and developmental stages further complicate the effective segmentation of nuclei. Most existing segmentation algorithms assume all the labeled nuclei as equal-sized with uniform labeling at least at the same developmental stage, which leads to a substantial amount of errors.

Deep learning (DL) is a promising technology for enhancing customized images across various fields. In specific applications, such as lineage tracing in C. elegans, DL can leverage deep spatial features and prior knowledge about the arrangement of fluorescence signals to highlight nuclear information in ambiguous regions. It also holds promise to reduce errors by any other segmentation algorithms that demand a high signal-to-noise ratio of images.

An effective pre-trained DL method DELICATE is designed for enhancing the automated lineage tracing procedures. This method greatly reduces the errors of StarryNite and significantly shortens the manual correction time with AceTree. This enhancement method facilitates fast and accurate establishment of lineage tracing for large-scale 550-cell analyzing data.

1. A method for generating a morphological atlas of an embryo comprising the steps of:
receiving a plurality of 3D images of the embryo representative of the morphological process of embryonic cells from a first predetermined cell population to a second predetermined cell population;
processing the plurality of 3D images to derive nucleus lineage information associated with each nucleus of the embryonic cells during the morphological process;
performing a membrane segmentation procedure to segment the 3D images into membrane segments; and
combining the nucleus lineage information and the membrane segments to generate the morphological atlas of the embryo.

2. The method for generating a morphological atlas as claimed in claim 1, wherein the membrane segmentation procedure includes a machine learning processor comprising an UNet Transformer (TUNETr) arranged to be pre-trained by annotated images representing a range of embryonic developmental stages and imaging conditions.

3. The method for generating a morphological atlas as claimed in claim 2, wherein the TUNETr is adapted to utilize the capability of a large deep neural network for convoluting voxels of 3D volumes with corresponding neighboring voxels.

4. The method for generating a morphological atlas as claimed in claim 3, wherein the membrane segmentation procedure utilizes a topology-constraint loss function in voxel-wise recognition to regularize cellular boundaries.

5. The method for generating a morphological atlas as claimed in claim 4, wherein the topology-constraint loss function comprises a geometrical loss L_{g} and topological loss Lₜ, wherein the geometrical loss is derived from mean square error (MSE) and the topological loss is a topological structural difference of the prediction and ground truth 3D images (Euclidean distance transformed).

6. The method for generating a morphological atlas as claimed in claim 5, wherein the annotation of images is carried out by a human visual inspection method and trained DNN method, such that the human visual inspection method is adapted to annotate a set of ground truth (GT) images for training the DNN for annotation.

7. The method for generating a morphological atlas as claimed in claim 6, wherein the annotated images comprise a substantial synthetic pseudo GT images.

8. The method for generating a morphological atlas as claimed in claim 7, wherein the synthetic pseudo GT images are generated by a step of manually adjusting the set of GT images.

9. The method for generating a morphological atlas as claimed in claim 8, wherein the step of manually adjusting the set of ground truth images comprises a human-in-the-loop step, wherein the human-in-the-loop step provides location prompts for tuning, eliminating irrelevant surroundings, and refining membrane recognition to reasonable positions and sizes to form the synthetic pseudo GT images.

10. The method for generating a morphological atlas as claimed in claim 9, wherein the synthetic pseudo GT images comprise membrane annotations which are constrained from real cell shape and embryos' edges that are tripled in thickness, for dragging DNN's attentions to the weak imaging area.

11. The method for generating a morphological atlas as claimed in claim 10, wherein the TUNETr is adapted to generate reliable Nucleus-prompting seeds and avoid erroneous segmentation in extremely ambiguous imaging areas.

12. The method for generating a morphological atlas as claimed in claim 11, wherein the TUNETr is adapted to use independent locations seeds to group points near cell margins and assigns weights to graph edges to avoid erroneous segmentation in extremely ambiguous imaging areas.

13. A system for generating a morphological atlas of an embryo, comprising:
a cell imaging unit arranged to receive a plurality of 3D images of the embryo representative of the morphological process of embryonic cells from a first predetermined cell population to a second predetermined cell population;
a nucleus tracing processor arranged to process the plurality of 3D images to derive nucleus lineage information associated with each nucleus of the embryonic cells during the morphological process;
an Encoding Module arranged to perform a membrane segmentation procedure to segment the 3D images into membrane segments; and
a Decoding Module arranged to combine the nucleus lineage information and the membrane segments to generate the morphological atlas of the embryo.

14. The system for generating a morphological atlas as claimed in claim 13, wherein the Encoding Module comprises a Swin Transformer Convolution Encoder Module.

15. The system for generating a morphological atlas as claimed in claim 14, wherein the Swin Transformer Convolution Encoder Module comprises a Patch Partition layer, a Linear Embedding layer, and a plurality of Swin Transformer blocks (STBs) and Linear Patch Merging (LPM) layers.

16. The system for generating a morphological atlas as claimed in claim 15, wherein each of the Swin Transformer blocks is immediately followed by a Linear Patch Merging (LPM) layer.

17. The system for generating a morphological atlas as claimed in claim 16, wherein the Encoder Module comprises four Swin Transformer blocks and four Linear Patch Merging layers.

18. The system for generating a morphological atlas as claimed in claim 17, wherein the Decoder Module comprises a plurality of Convolution Residual Regression Modules, wherein each of the Convolution Residual Regression Modules is adapted to take an output from a corresponding layer in the Encoder Module and added to an output from the previous layer of Decoder Module.

19. The system for generating a morphological atlas as claimed in claim 18, wherein each of the Swin Transformer blocks comprises one or more consecutive Transformer Blocks.

20. The system for generating a morphological atlas as claimed in claim 19, wherein each of the Transformer Blocks comprises a shifted window based multi-headed self-attention (MSA) module and a Multilayer Perceptron (MLP) layer, wherein each MSA module and MLP layer has a Layer Normalisation (LN) layer is applied therebefore, and a residual connection is applied after each module.
